(19) United States
(12) Patent Application Publication
(10) Pub. No.: US 2011/0191674 A1
(43) Pub. Date: Aug. 4, 2011

(54) Virtual musical interface in a haptic virtual environment

(75) Inventors: Curt Rawley, WINDHAM, NH (US); Georges Grinstein, Ashby, MA (US); Alex Bauman, Lowell, MA (US); Jon Victorine, Manchester-by-the-sea, MA (US); Abdulrahmane Bezzati, Lowell, MA (US); Vivek Gupta, Littleton, MA (US); John Sharko, Harvard, MA (US); Paul Bubert, Manchester, NH (US)

(73) Assignee: SENSABLE TECHNOLOGIES, INC., WOBURN, MA (US)

(21) Appl. No.: 11/659,650

(22) PCT Filed: Aug. 4, 2005
(86) PCT No.: PCT/US05/27643

§ 371 Date: Apr. 3, 2009

Related U.S. Application Data
(60) Provisional application No. 60/599,804, filed on Aug. 6, 2004.

(51) Int. Cl. G06F 3/01; G06F 3/16

(52) U.S. Cl. 715/702; 715/727

(57) ABSTRACT

The invention relates to a virtual musical interface for composing, editing, and/or performing audio works. In certain embodiments, the invention relates to a virtual musical interface rendered as a virtual object in a haptic environment, where one or more parameters of the virtual object are associated with one or more audio attributes. Thus, methods and systems of the invention provide audio, visual, and/or haptic feedback in response to a user interaction.

### CROSS-REFERENCE TO RELATED APPLICATIONS

This application claims priority to and the benefit of U.S. provisional patent application Ser. No. 60/599,804, filed Aug. 6, 2004, the text of which is incorporated by reference herein in its entirety.

### FIELD OF THE INVENTION

The invention relates generally to a virtual musical interface for composing, editing, and/or performing audio works. More particularly, in certain embodiments, the invention relates to methods and systems for rendering a virtual musical interface as a virtual object in a haptic environment, where one or more parameters of the virtual object are associated with one or more audio attributes.

### BACKGROUND OF THE INVENTION

Data representing a musical composition, audio work, or other sound recording may be created and manipulated using conventional editing and playback software. For example, a musician may play back a portion of a sound file and copy or edit a section of the file using certain software applications designed for use with a graphical interface device, such as a mouse. The software may provide graphical representations of sliders, knobs, buttons, or pointers that are displayed on a computer screen and that the user can manipulate by operating a mouse, thereby controlling sound playback and editing. In some applications, a graphical representation of a sound file is displayed as a time versus amplitude graph. Certain more elaborate systems may provide a hardware control such as a jog-shuttle wheel that the user can rotate to play back a sound selection forward or in reverse.

The playback of digital music data as performed by such conventional software is typically static. As such, conventional software does not typically allow a user to easily edit digital music during playback. Conventional software also does not typically provide a way to intuitively manipulate music. Accordingly, musicians, game designers, instructors, simulation/model designers, music producers, multimedia producers, and other entities interested in manipulating audio data have a continuing interest in developing and using more versatile and flexible audio manipulation tools.

Attempts have been made to provide a user with more interactive audio manipulation tools. For example, U.S. Pat. No. 6,703,550 by Chu describes a method of navigating through sound data in which a user experiences a particular sensation when a pre-positioned marker is reached during playback. However, there remains a need for tools that allow more intuitive interaction with, and manipulation of, audio works.

### SUMMARY OF THE INVENTION

By representing an audio work as a haptically-rendered, modifiable virtual object, methods and systems of the invention provide touch, visual, and audio feedback to assist a user in creating and editing audio works in real-time. The modifiable virtual object serves as a virtual musical interface with which a user can compose, edit, and/or perform an audio work. The musical interface is rendered in a haptic virtual environment, allowing user interaction via a haptic interface device or other user input device.

For example, a virtual musical interface may be rendered as a three-dimensional surface within a virtual environment, where elements or regions of the three-dimensional surface are associated with one or more specific musical attributes. In one embodiment, different regions of a three-dimensional, haptically rendered surface are associated with different pitches, such that moving a cursor to a predetermined region of the surface results in a specific pitch being sounded.

By rendering the virtual musical interface in a haptic environment, a user is allowed to “feel” and respond to audio feedback by controlling a haptic interface device, such as a PHANTOM® device produced by SensAble Technologies, Inc., of Woburn, Mass. The user senses kinesthetic, tactile, and/or other touch feedback through the haptic interface device as she interacts with the virtual musical interface. Thus, systems and methods of the invention create an environment where audio signals may be associated with both visual and haptic sensations, and wherein the user can create, modify and/or edit audio signals through the haptic interface. A user is able to physically interact with a musical composition and/or musical instrument in a virtual environment, without the need for expensive musical editing equipment or actual musical instruments.

In an illustrative embodiment, a musical instrument is represented by a three-dimensional surface in a haptic virtual environment. The surface can be divided into a number of regions, for example, each corresponding to a different musical pitch. The user controls a haptic interface device to move a cursor over the surface, and the haptic interface device provides force feedback that allows the user to “feel” the cursor moving over the virtual surface. The haptic interface device also allows the user to modify the shape of the surface, for example, by stretching, pushing into, or pulling out from the surface. The act of stretching, pushing, or pulling may also be felt by the user. The deformation of the surface may be linked to a musical attribute, such that, for example, pushing into the surface lowers the pitch corresponding to the region being deformed, while pulling out from the surface raises the pitch. Following deformation of the surface, the user experiences different audio, visual, and/or haptic feedback as the user moves the cursor over the modified surface. Thus, in this embodiment, the virtual musical interface operates as a customizable musical instrument that can be felt, viewed, heard, and played by a user.

Certain embodiments of the invention allow further customization by associating colors, textures, heights, or other graphical or geometric parameters of the virtual musical interface with different audio attributes. For example, a region of the virtual musical interface may be subdivided such that different locations within a region correspond to sound produced by different musical instruments. In this way, a user can control, hear, and “feel” changes in timbre, or tone color, by moving the cursor to the appropriate locations.

In certain embodiments of the invention, the virtual musical interface is rendered as a three-dimensional surface in a virtual environment, allowing a user to produce a variety of sounds by moving the cursor around the virtual environment and/or by deforming the surface of the virtual musical interface. The haptic interface device may provide a force feedback to the user that corresponds to the specific sound being made, according to a user interaction with the virtual musical interface. For example, the further the surface is deformed, the greater the resistance provided to the user, and the greater the change in a particular audio attribute produced, such as pitch or volume. Audio attributes may be associated with various sensory stimuli. For example, vibrato in a note may be sensed by a user as vibration via a haptic interface device.

The invention also provides methods and systems for interacting with a recorded audio work, such as a recording of a musical composition. The recorded audio work can be stored within a computer, for example, as a MIDI file, MP3 file, or any other appropriate digitally-based audio storage language. A three-dimensional surface may be generated such that the audio attributes of a specific song are associated with different regions and/or properties of the surface, where the musical composition can be “played” by moving the cursor over the surface along a predetermined path. For example, a song may be represented as a specific path across the haptically-rendered three-dimensional surface. The musical composition may be played back by simply tracing the cursor along the predetermined path. Melodies and harmonies may be represented separately or together, using one or more virtual surfaces (or other virtual objects). For example, polyphonic audio works may be represented as one or more paths traveling along one or more three-dimensional surfaces.

Furthermore, the user can interact with the song as it is played. For example, the song path may be represented by a valley in the surface, such that a user can play the song by simply tracing the haptic interface device through the valley. The haptic interface device provides force feedback to the user such that, for example, following the valley provides the least resistance to the user. The user may be “guided” along the path automatically (i.e. during automatic playback), or the user may move along the path without guidance. In an example embodiment, pushing the cursor into, or pulling it away from, the surface modifies an audio attribute of the song, while moving the cursor along the surface away from the designated path modifies a different audio attribute. For example, pushing or pulling the surface could increase or decrease the volume, while moving the cursor up one side of the valley could increase or decrease the pitch of the note associated with that position in the valley. As a result, the song can be modified and/or edited in real time as it is played.

In certain embodiments, the invention provides a virtual “parking space” for the haptic interface device to rest when not in use. This may be used, for example, to prevent inadvertent modification of, and/or interference with, the musical composition as it is being performed.

A haptic interface device allows for force feedback to be provided to the user as the song is played, based, for example, on the specific sound being made. As a result, a user can experience a range of touch- and sight-based stimuli that correspond with the audio attributes of the song being played, as well as the modifications and edits to the song being made by the user in real time.

The virtual musical interface can be of use in musical education, editing and producing musical compositions, creating musical compositions, and creating sound effects and music for computer software, such as a computer game. The invention allows a musical instrument or musical composition to be represented in a virtual environment, and allows a user to create and modify sounds in real time by interacting with a virtual musical interface. Because it is rendered in a haptic virtual environment, the virtual musical interface provides an interactive touch- and vision-based representation of sounds.

In certain embodiments, the invention can be of great use to those with hearing, sight, and/or other sensory and/or cognitive disabilities. For example, by providing an environment wherein sound generated by a musical instrument or musical composition is converted into visual and haptic information, an embodiment of the invention may provide a hearing-impaired user a way of sensing a song or playing a musical instrument through vision and touch. This can allow a deaf user to interact with and experience sound and music in a manner which would otherwise be impossible. Similarly, a sight-impaired user may be able to interact with and experience visual information through both sound and touch.

In one aspect, the invention provides a method of haptically rendering a virtual musical interface. The method includes the steps of rendering a virtual object in a haptic virtual environment and associating at least one parameter of the virtual object with an audio attribute to create a musical interface whereby a user is provided audio and haptic feedback in response to a user interaction. Rendering the virtual object in a haptic virtual environment may include graphically and haptically rendering the virtual object. The audio attribute of the virtual musical interface may include at least one of tone, volume, pitch, attack rate, decay rate, sustain rate, vibrato, sostenuto, or base. The virtual object may include a three-dimensional surface. The virtual environment may be populated with one or more virtual objects.

In certain embodiments of the invention, the user interaction includes a deformation of the three-dimensional surface. In some embodiments of the invention, the user interaction includes movement substantially along a surface of the virtual object. The user interaction may further include manipulating a portion of the surface to modify the audio attribute. In certain embodiments, manipulating the portion of the surface includes deforming the surface. In certain embodiments of the invention, the user interaction includes a deformation of the three-dimensional surface. In certain embodiments, the virtual object may include a visco-elastically and/or plastically deformable surface.

The at least one parameter of the virtual object may include one or more geometric parameters, texture parameters, and/or color parameters of at least one point on the three-dimensional surface. In certain embodiments, the haptic feedback includes a force transmitted to the user through the interface device. In some embodiments of the invention, the haptic interface device includes a haptic device providing force feedback to actuators operating in at least three degrees of freedom. In other embodiments, the haptic interface device includes a haptic device providing force feedback to actuators operating in at least six degrees of freedom. In other embodiments, there are one, two, three, four, five, six, seven, eight, nine, or more degrees of freedom.

The user interaction may include manipulation of an interface device. Manipulation of the interface device may correspond with at least one of a manipulation of a portion of the surface and a movement within the haptic virtual environment. In some embodiments, the interface device includes at least one of a haptic interface device, a mouse, a spaceball, a trackball, a wheel, a stylus, a sensory glove, a voice-responsive device, a game controller, a joystick, a remote control, a transceiver, a button, a gripper, a pressure pad, a pinch device, or a pressure switch.

In some embodiments, determining the force feedback includes determining a force feedback vector and sending the force feedback to the user through the haptic interface device. In some embodiments of the invention, rendering a virtual object in a haptic virtual environment includes the steps of accessing data in a graphics pipeline of a three-dimensional graphics application, and interpreting the data for use in a haptic rendering of the virtual object.

In some embodiments of the invention, the virtual musical interface is a virtual musical instrument, while in other embodiments the virtual musical interface is a representation of a musical composition. In certain embodiments, the virtual object includes a representation of a musical composition, wherein the user is provided audio and haptic feedback upon playback of the musical composition.

In another aspect, the invention provides a method of haptically rendering a musical composition. The method includes the steps of rendering a virtual object in a haptic virtual environment, wherein the virtual object includes a representation of a musical composition, and associating at least one parameter of the virtual object with an audio attribute to provide a user with audio and haptic feedback upon playback of the musical composition. The virtual object may include a three-dimensional surface, and the representation of the musical composition may include a predetermined path along the three-dimensional surface.

In certain embodiments of the invention, the method further includes the step of playing back the musical composition. Playing back the musical composition may include tracing a cursor along the predetermined path. In some embodiments, the musical composition can be modified through a user interaction. This user interaction may include movement of the cursor away from the predetermined path and/or substantially along the three-dimensional surface. The audio attribute may include at least one of tone, volume, pitch, attack rate, decay rate, sustain rate, vibrato, sostenuto, or base.

The user interaction may include modification of at least one member of the group consisting of a geometric parameter, a texture parameter, and a color parameter of at least one point on the three-dimensional surface. In some embodiments, the modification of the geometric parameter includes deforming a portion of the three-dimensional surface. In certain embodiments of the invention, the user interaction is performed by manipulating an interface device.

The disclosed technology can be used to form a virtual musical instrument that facilitates learning, production, and other types of interactions associated with audio presentations, such as musical compositions. For example, a virtual musical instrument that incorporates, separately or in any combination, graphical, haptic, kinesthetic, tactile, touch, and/or other types of sensory parameters with audio parameters may enable a student, a game designer, a simulation/model designer, a music/multimedia producer or other interested entities to readily generate and/or modify one or more musical compositions of interest. By mapping the audio parameters/attributes of a musical composition with other sensory attributes, the disclosed technology enables a user to modify the musical composition in response to graphical, haptic, kinesthetic, tactile, touch, and/or other types of non-audio, sensory inputs in substantially real time and with relative ease rather than having to laboriously and statically modify the underlying audio attributes of the musical composition. In some embodiments, such inputs/interactions can be conveyed using a force-feedback device and/or substantially any other type of device that can capture dynamic user input.

In one illustrative embodiment, the disclosed technology may be used to develop systems and perform methods in which one or more audio attributes (e.g., tone, volume, pitch, attack rate, decay rate, sustain rate, vibrato, sostenuto, base, etc.) associated with a musical composition are accessed and associated with a graphical representation (e.g., a three-dimensional surface, a three-dimensional volume, etc.) of the musical composition and where one or more of such audio attributes can be modified in response to an interaction directed at the graphical representation of the musical composition. The audio attributes may be accessed from a pre-existing data repository, such as from a MIDI file and/or from a non-MIDI file (may include digital audio samples), or may be dynamically generated during the operation of the disclosed technology. The corresponding musical composition may further include one or more voices, monodies, and/or polyphonies. The graphical representation of the musical composition may represent a range of modification of one or more of the associated audio attributes and such audio attributes may be further associated with one or more graphical parameters, such as, for example, texture, coordinate location (e.g., x, y, z, normal vector), color (e.g., r, g, b, HSL, and/or other color domain set), depth, height, alpha, reflectivity, luminosity, translucency, and/or other graphical parameters of the graphical representation.

The interaction directed at the graphical representation of the musical composition may correspond, for example, to haptic interactions (associated with, for example, a force, a direction, a position, a velocity, an acceleration, and/or a moment), tactile interactions (associated with a texture), graphical interactions, and/or any other type of interaction capable of affecting or being mapped to the graphical parameters of a graphical representation and which may be further received via an input device (e.g., a mouse, a spaceball, a trackball, a stylus, a sensory glove, a voice-responsive device, a haptic interface device, a game controller, a remote control, and/or a transceiver) that is communicatively coupled to a digital data processing device that forms or displays the graphical representation and/or that plays or otherwise manipulates the musical composition. For example, an interaction directed at the graphical representation may manipulate a value of a haptic parameter that is associated with one or more audio attributes and/or graphical parameters of the graphical representation, where the modified audio attributes resulting from such interaction are based at least partly on the value of the haptic parameter. By way of non-limiting example, a modified audio attribute may be calculated based on a mathematical relationship with one or more haptic parameters, such as where the modified audio attribute is a linear function of a haptic parameter, an average of multiple haptic parameters, a product of multiple haptic parameters, an offset between multiple haptic parameters, and/or any other type of function involving one or more haptic parameters.

Audio attributes that are modified in response to such interactions may retain their modified state, revert to their unmodified state after a predetermined period of time, or revert to their unmodified state upon the occurrence of an event. For example, a reversion to an unmodified state can occur in response to a cessation of a haptic interaction, a cessation of a tactile interaction, a recordation of the modified audio attributes, a recordation of an original or modified musical composition, and/or upon completion of a performance of a musical composition. Several versions of the musical composition that either incorporate the original/unmodified audio attributes or the modified audio attributes may be stored in a memory (e.g., in a MIDI file format or a non-MIDI file format, such as .WAV, .MP3, .AVI, Quicktime™, etc.) that is integral with or communicatively coupled to a digital data processing device and can thus be played/performed concurrently or in series. A stored musical composition may also be transmitted to other digital data processing devices via a network.

A graphical representation of a musical instrument may be associated with one or more different musical compositions and such different musical compositions may be performed concurrently with or instead of the original musical composition in response to interactions directed at the graphical representation. A graphical representation of a first musical instrument may also be displayed with the graphical representations of one or more different musical compositions, where such musical compositions can be performed based, at least in part, on an interaction directed at a space between the graphical representations, as may occur, for example, when there is an overlap in the display of the graphical representations.

Those skilled in the art will recognize that the disclosed technology can facilitate the performance, composition, and/or manipulation of musical compositions, with or without modified audio attributes, in a wide variety of applications or environments, such as in games, learning exercises, simulations/models, music productions, multimedia productions, etc.

In one illustrative embodiment, the disclosed technology can be used to develop systems and perform methods in which virtual musical instruments are haptically rendered. A graphical representation (e.g., a three-dimensional volumetric surface) of a virtual musical instrument may be formed and one or more parameters (corresponding to, for example, a surface, a surface, etc.) of the graphical representation may be associated with one or more audio attributes (e.g., pitch, tone, volume, decay, vibrato, sostenuto, base, attack rate, decay rate, sustain rate, etc.) of the virtual musical instrument. The disclosed technology enables one or more of the audio attributes of the virtual musical instrument to be modified in response to a haptic interaction directed at one or more of the parameters of the graphical representation of the virtual musical instrument. The parameters of the graphical representation may correspond to, for example, one or more geometric parameters, texture parameters, color parameters, and/or haptic parameters. In some embodiments, the graphical representation of a virtual musical instrument may also substantially emulate a physical configuration of a physical musical instrument or other sound producing object, or a part thereof. In other embodiments, the graphical representation of a virtual instrument may not physically resemble a physical sound producing instrument or object. An audio attribute modified in response to a haptic interaction may be stored in its modified state and/or revert to its unmodified state after a predetermined period of time or upon the occurrence of an event (e.g., a cessation in the haptic interaction, a completion of a musical composition performance, etc.).

The haptic interaction that triggers the modification in the audio attribute may be received or detected during a performance of a musical composition using a virtual musical instrument. The haptic interaction and/or one or more other haptic interactions may also trigger the performance of the musical composition using the virtual musical instrument. The disclosed technology may be used to form a haptic representation of a virtual musical instrument and such haptic representation may be further associated with a graphical representation of the virtual musical instrument where a musical composition can be performed using the virtual musical instrument and in response to one or more haptic interactions associated with the haptic representation of the virtual musical instrument. The haptic representation may also be further associated with one or more audio attributes of the virtual musical instrument. One or more of the haptic interactions triggering the performance of the musical composition may correspond to a type of physical interaction applied to a corresponding physical musical instrument and such physical musical instrument may be formed to exhibit substantially the same modified audio attribute as that of a virtual musical instrument.

The graphical representation of the virtual musical instrument along with the modified audio attributes and related haptic representations and/or interactions may be stored in a digital representation of a corresponding musical composition. This musical composition can be played back at a later time and can be modified in response to one or more haptic interactions and/or in response to a modification in the graphical representation of the virtual musical instrument received during the play-back of the musical composition.

In one illustrative embodiment, the disclosed technology may be used to develop systems and perform methods in which a virtual object (e.g., a graphical surface, a three-dimensional volumetric surface) can be rendered in a haptic virtual environment and where a parameter (e.g., geometric parameter, texture parameter, graphical parameter, haptic parameter, etc.) of the virtual object can be associated with a musical parameter. One or more haptic interactions with the virtual object may serve as a basis for forming/defining the musical parameter. The musical parameter may be synchronized with haptic cues provided via a haptic virtual environment and/or may be modified in response to modification of a virtual object's parameter. In some embodiments, a modified musical parameter may return to its prior, unmodified state after a predetermined period of time or upon the occurrence of an event. A musical composition incorporating a musical parameter can be performed and at least part of the virtual object may graphically and/or haptically respond when the musical parameter is played.

In one illustrative embodiment, the disclosed technology may be used to develop systems and perform methods in which audio output (e.g., actual audible sounds, digital files representing sound, etc.) can be produced using haptically rendered virtual objects. One or more virtual objects may be haptically rendered in a haptic virtual environment and may be associated with/mapped to one or more audio parameters. A volume through which one or more of the virtual objects travel may also be rendered and the movement of such virtual objects through the volume can produce a corresponding audio output. The disclosed technology enables modification of the audio output in response to modifying the volume through which the virtual object travels. For example, insertion of additional virtual objects within a volume can result in an interaction that modifies an audio output. One or more of the virtual objects can also be traversed at particular time periods (e.g., currently), as may be denoted by a virtual pointer.

In one illustrative embodiment, the disclosed technology may provide a virtual musical instrument that is playable, at least in part, on a digital data processing device. A virtual musical instrument may include a mapping relationship that associates/maps one or more audio attributes (e.g., tone, volume, pitch, attack rate, decay rate, sustain rate, vibrato, sostenuto, base, etc.) of one or more musical compositions with graphical parameters (e.g., texture, coordinate location, color, depth, height, etc.) of a graphical surface, where one or more of the musical compositions can be modified in response to interactions (e.g., haptic interactions, tactile interactions, and/or graphical interactions) directed at the graphical surface. One or more of the audio attributes may be stored in a MIDI file and/or in a non-MIDI file. A modified musical composition may also be stored in a MIDI file and/or non-MIDI file along with its corresponding mapping relationship. The modified musical composition may include one or more voices, monodies, or polyphonies and may correspond to and/or be incorporated into, for example, a game, a learning exercise, a simulation, a model, a music production, and/or a multimedia production. The mapping relationship may further associate one or more audio attributes with one or more haptic parameters and the values of such haptic parameters may be determined based on interactions (corresponding to, for example, a force, a direction, a velocity, a position, an acceleration, a moment, and/or the like) directed at the graphical surface.

A virtual musical instrument may also include multiple graphical surfaces. For example, a first and a second graphical surface may be positioned substantially adjacent to each other and an original and/or modified musical composition may be played in response to one or more interactions associated with a traversal of the first and second graphical surfaces. In another example, a second graphical surface may at least partially overlay a first graphical surface and an original and/or modified musical composition can be played in response to one or more interactions associated with a traversal of the first and second surfaces and/or a traversal of a space/volume between such overlapping surfaces.

In one illustrative embodiment, the disclosed technology may be used to develop systems and perform methods that facilitate the modification of audio attributes of one or more musical compositions. A mapping data structure may associate one or more audio attributes (e.g., tone, volume, pitch, attack rate, decay rate, sustain rate, vibrato, sostenuto, base, etc.) associated with a musical composition with one or more graphical parameters (corresponding to, for example, texture, coordinate location, color, depth, height, etc.) associated with a graphical surface and a calculation software process may subsequently calculate modified values of the associated audio attributes in response to interactions directed at the graphical surface. The disclosed systems may include an input device (e.g., mouse, spaceball, trackball, stylus, sensory glove, voice-responsive device, haptic interface device, game controller, remote control, transceiver, etc.) that directs interactions at a graphical surface. The disclosed systems may also include an audio element that forms an audible rendition of the musical composition that may incorporate the modified values of the associated audio attributes and/or a rendering software process that renders the graphical surface on a display of a digital data processing device. Modified values of audio attributes may be stored in a memory, such as in a MIDI file format, and may be performed in a wide variety of applications and environments, such as in games, learning exercises, simulations/models, music productions, and/or multimedia productions.

The audio attributes may be accessed from a MIDI file, a non-MIDI file, and/or from other sources integral with and/or communicatively coupled to the disclosed systems. The musical composition may include a voice, a monody, and/or a polyphony. Further, the graphical surface may represent a range of modification of associated audio attributes. Interactions directed at a graphical surface may correspond to one or more tactile interactions associated with textures and/or one or more haptic interactions associated with a force, a direction, a velocity, a position, an acceleration and/or a moment. The mapping data structure may further relate haptic parameters with associated audio attributes and/or graphical parameters and the calculation software process may calculate modified values for the associated audio attributes based, at least in part, on the values of the haptic parameters.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 schematically illustrates an exemplary system capable of rendering a virtual musical instrument, in accordance with one embodiment of the invention;

FIGS. 2A and 2B are screen shot representations of an illustrative two-dimensional virtual musical instrument whose audio presentations may be manipulated based on haptic interactions directed to its two-dimensional surface, in accordance with one embodiment of the invention;

FIGS. 3A and 3B illustrate an exemplary three-dimensional surface of a virtual musical instrument in which particular heights within the surface are mapped to corresponding pitch levels of an audio presentation, in accordance with one embodiment of the invention;

FIGS. 4A and 4B illustrate an exemplary surface of a virtual musical instrument in which particular heights within the surface are mapped to corresponding volume levels of an audio presentation, in accordance with one embodiment of the invention;

FIG. 5 is a screen shot representation of an illustrative three-dimensional virtual musical instrument whose audio/musical composition presentations may be manipulated based on interactions directed to its three-dimensional surface, in accordance with one embodiment of the invention;

FIG. 6 is a screen shot representation of an illustrative three-dimensional virtual musical instrument incorporating the same song, but different graphical surface and coloration attributes relative to that of the FIG. 5 virtual musical instrument, thereby resulting in a different song curve, in accordance with one embodiment of the invention;

FIG. 7 is a screen shot representation showing one illustrative technique for visually indicating to a user the presence of a haptically applied pressure to the virtual musical instrument of FIG. 5;

FIGS. 8A and 8B are screen shot representations of a virtual musical instrument showing one illustrative technique for providing a user with a visual indication of a haptic boundary and an increase in a haptically applied pressure, in accordance with one embodiment of the invention;

FIG. 9 is a screen shot representation incorporating a different coloration scheme to the virtual musical instrument depicted in FIG. 5;

FIG. 10A provides an illustrative representation of a song curve, in accordance with one embodiment of the invention;

FIG. 10B provides a graphical representation of a virtual musical instrument, which includes the song curve of FIG. 10A;

FIGS. 11A and 11B are screenshots illustrating the effects of graphical changes in an illustrative virtual musical instrument and how a corresponding song curve may conform to such graphical changes, in accordance with one embodiment of the invention;

FIG. 12 illustrates an exemplary virtual musical instrument with overlapping surfaces, in accordance with one embodiment of the invention;

FIG. 13 illustrates an exemplary methodology for mapping graphical surface parameters to musical/audio parameters, in accordance with one embodiment of the invention;

FIG. 14 illustrates a graphical view of a song playback represented by a colored stream, in accordance with one embodiment of the invention;

FIG. 15 shows a virtual musical instrument in accordance with one embodiment of the disclosed technology, where a user views the instrument from the point of view of the cursor, in accordance with one embodiment of the invention;

FIG. 16 displays a screenshot of graphical user interface (“GUI”) controls of the present disclosure, in accordance with one embodiment of the invention;

FIG. 17 illustrates GUI controls used for playback and recording, in accordance with one embodiment of the invention;

FIG. 18 is a screen shot representation of a set of option windows for sound parameter mapping, in accordance with one embodiment of the invention; and

FIG. 19 illustrates an example methodology for generating MIDI events, in accordance with one embodiment of the invention.

### DETAILED DESCRIPTION

Throughout the description, where an apparatus is described as having, including, or comprising specific components, or where systems, processes, and methods are described as having, including, or comprising specific steps, it is contemplated that, additionally, there are apparati of the present invention that consist essentially of, or consist of, the recited components, and that there are systems, processes, and methods of the present invention that consist essentially of, or consist of, the recited steps.

It should be understood that the order of steps or order for performing certain actions is immaterial so long as the invention remains operable. Moreover, two or more steps or actions may be conducted simultaneously.

Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes, sizes, and colors of illustrated elements/aspects are also exemplary and unless otherwise specified, can be altered without materially affecting or limiting the disclosed technology. In the drawings, like reference characters generally refer to corresponding parts throughout the different views.

For the purposes of this disclosure, the term “substantially” can be broadly construed to indicate a precise relationship, condition, arrangement, orientation, and/or other characteristic, as well as deviations thereof as understood by one of ordinary skill in the art, to the extent that such deviations do not materially affect or limit the disclosed methods and systems.

For the purposes of this disclosure, the term “digital data processing device” may refer to a personal computer, computer workstation (e.g., Sun, HP), laptop computer, server computer, mainframe computer, audio generation/synthesis device, multimedia production device, handheld device (e.g., personal digital assistant, Pocket PC, cellular telephone, etc.), information appliance, or any other type of generic or special-purpose, processor-controlled device capable of receiving, processing, and/or transmitting digital data. A processor refers to the logic circuitry that responds to and processes instructions (not shown) that drive digital data processing devices and can include, without limitation, a central processing unit, an arithmetic logic unit, an application specific integrated circuit, a task engine, and/or any combinations, arrangements, or multiples thereof.

For the purposes of this disclosure, the term “network” may refer to a series of network nodes that may be interconnected by network devices and communication lines (e.g., public carrier lines, private lines, satellite lines, etc.) that enable the network nodes to communicate. The transfer of data (e.g., messages) between network nodes may be facilitated by network devices, such as routers, switches, multiplexers, bridges, gateways, etc., that can manipulate and/or route data from an originating node to a destination node regardless of any dissimilarities in the network topology (e.g., bus, star, token ring), spatial distance (local, metropolitan, or wide area network), transmission technology (e.g., TCP/IP, Systems Network Architecture), data type (e.g., data, voice, video, or multimedia), nature of connection (e.g., switched, non-switched, dial-up, dedicated, or virtual), and/or physical link (e.g., optical fiber, coaxial cable, twisted pair, wireless, etc.) between the originating and destination network nodes.

For the purposes of this disclosure the terms “virtual musical instrument”, “virtual musical interface,” and “virtual instrument” are used interchangeably and refer to a graphically and/or haptically rendered virtual object (e.g. a curve, surface, and/or volume) whereby a musical composition and/or other sound-related object (or collections of objects) is generated, played, and/or modified, for example, by user interaction. In certain embodiments, the virtual musical interface may include a representation of one or more musical compositions and/or sound-related objects.

For the purposes of this disclosure, the term “musical composition” may refer to a discrete pitch, a piece of music, a song, a voice clip, an audio clip, an audio output, a sound-related object, and/or any combinations, multitudes, or subsets thereof.

In brief overview, embodiments described herein provide systems and methods for rendering a virtual instrument that may be performed and/or modified via user interaction with the instrument. The instrument may be displayed graphically (e.g., as a two-dimensional surface/diagram or as a three-dimensional surface/volume) and, preferably, includes a variety of interrelated (also referred to herein as “mapped” or “associated”) parameter types, such as combinations of one or more graphical, haptic, tactile, and/or audio (e.g., musical) parameters. As such, musical parameters of a virtual instrument may be modified by changing surface parameters of the instrument. For the purposes of this disclosure, the terms, “parameters,” “properties,” and “attributes,” can be used interchangeably. Additionally, in some embodiments, a stored musical composition (e.g., a song) may be played on a virtual instrument and graphically demarcated/represented as a curve flowing through a graphical rendering of the virtual instrument. A user may then listen to the song by allowing a cursor to traverse the curve. A user may also interpret and/or modify the song by moving the cursor off the demarcated curve thus playing other sections of the rendered instrument.

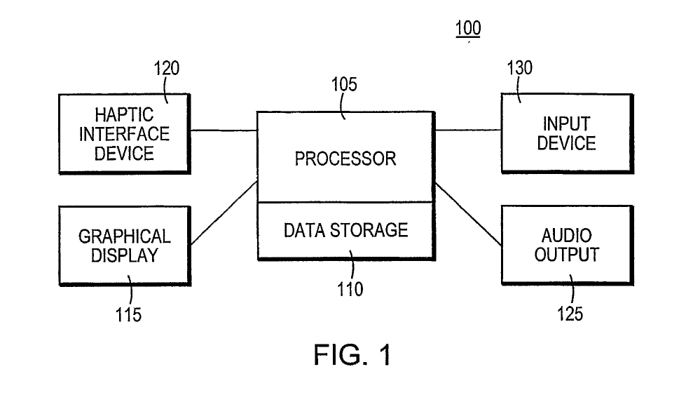

FIG. 1 is a schematic diagram of an illustrative system 100 for rendering a dynamic, virtual musical instrument capable of being modified and/or played via graphical and/or haptic user interaction. The diagram illustrates the general relation between a digital data processing device 105 (also referred to herein, without limitation, as a “computer processor”), a data storage device 110, a graphical display 115, a haptic interface device 120, an audio output device 125, and an input device 130.

In one illustrative embodiment, a computer processor 105 accesses data pertaining to interrelated graphical, audio, haptic, and/or tactile parameters from a data storage device 110 to form a virtual instrument and such data may be further rendered to provide a graphical representation of the virtual instrument that may be viewed on a graphical display 115. The graphical representation of the virtual instrument may include one or more line segments, curves, two-dimensional surfaces, and/or three-dimensional surfaces/volumes, separately or in any combination. The computer processor 105 may also haptically render the graphical surface of the virtual instrument, thereby enabling a user to haptically and/or tactically sense the graphical surface using a haptic interface device 120. Illustrative methods and systems that may be used to perform such haptic rendering are described, for example, in co-owned U.S. Pat. Nos. 6,191,796 to Tarr, 6,421,048 to Shih et al., 6,552,722 to Shih et al., 6,417,638 to Rodomista et al., 6,084,587 to Tarr et al., 5,587,937 to Massie et al., 6,867,770 to Payne, 6,111,577 to Zilles et al., and 6,671,651 to Goodwin et al., and in co-owned U.S. patent application Ser. Nos. 11/169,175 and 11/169,271 to Itkowitz et al., 09/356,289 to Rodomista et al., 10/017,148 to Jennings et al., and 60/613,550 to Kapoor, the texts of which are incorporated by reference herein in their entirety. Illustrative methods and systems that may be used to perform advanced graphical rendering in conjunction with the haptic rendering are described, for example, in co-owned U.S. patent application Ser. Nos. 10/697,548 to Levene et al., 10/697,174 to Levene et al., 10/733,860 to Berger, and 10/733,862 to Berger et al., the texts of which are incorporated by reference herein in their entirety.

In one embodiment, haptic rendering includes the steps of determining a haptic interface location in a virtual environment corresponding to a location of a haptic interface device in real space, determining a location of one or more points on a surface of a virtual object in the virtual environment, and determining an interaction force based at least partly on the haptic interface location and the location on the surface of the virtual object. For example, haptic rendering may include determining a force according to a location of a user-controlled haptic interface in relation to a surface of a virtual object in the virtual environment. If the virtual surface collides with the haptic interface location, a corresponding force is calculated and is applied to the user through the haptic interface device. Preferably, this occurs in real-time during the operation of the disclosed technology.

In order to allow a user to interact in the virtual environment both graphically and haptically, one embodiment of the invention includes generating user-interface input. Many three-dimensional graphics applications operate using a mouse or other 2D input device or controller. However, the haptic interface device is typically operable in more than two dimensions. For example, the haptic interface device may be the PHANTOM® device produced by SensAble Technologies, Inc., of Woburn, Mass., which can sense six degrees of freedom—x, y, z, pitch, roll, and yaw—while providing force feedback in three degrees of freedom—x, y, and z. An example device is a six degree of freedom force reflecting haptic interface device is described in co-owned U.S. Pat. No. 6,417,638, to Rodomista et al., the description of which is incorporated by reference herein in its entirety. Therefore, one embodiment of the invention includes generating user interface input by converting a three-dimensional position of a haptic interface device into a 2D cursor position, for example, via mouse cursor emulation. To further facilitate use of a haptic interface device with a three-dimensional graphics application, one embodiment of the invention includes the step of haptically rendering a user interface menu. Thus, menu items available in the three-dimensional graphics application, which are normally accessed using a 2D mouse, can be accessed using a haptic interface device that is operable in three dimensions. In a further embodiment, a boreline selection feature can be used, enabling a user to “snap to” a three dimensional position, such as a position corresponding to a menu item of a three-dimensional graphics application, without having to search in the “depth” direction for the desired position. An object can be selected based on whether it aligns (as viewed on a 2D screen) with a haptic interface location. This is described in U.S. Pat. No. 6,671,651 to Goodwin et al., the text of which is incorporated by reference herein in its entirety.

The computer processor 105, in some embodiments, associates parameters of the rendered surface with musical parameters. Such surface parameters may include geometric, kinesthetic, tactile, and other haptic properties of the surface. For example, surface parameters may comprise color, height, depth, spatial coordinates, virtual lighting, transparency, opacity, roughness, smoothness, and texture of the surface, and combinations thereof. Surface parameters may also comprise haptic parameters such as pressure/force, velocity, direction, acceleration, moment and/or other types of detectable movement or interaction with the haptic interface device. Musical/audio parameters may include and/or correspond to, for example, pitch, volume, aftertouch, continuous controllers, attack rate, decay rate, sustain rate, vibrato, sostenuto, base, a pitch, a clip of a musical piece, a voice clip, tone, and/or the length of a note. The association between surface parameters and musical parameters may be based on a mapping relationship defined within a mapping data structure (e.g., a table) that identifies particular values and/or ranges of values for such parameters and their interrelationships. The interrelationship between these associated parameters can be based on one or more mathematical relationships.

In one illustrative embodiment, the origin of a coordinate system of a rendered surface of a virtual musical instrument may be associated with a C-sharp pitch as played on a piano and a blue color may be associated with a voice clip. Thus when a proxy such as a cursor is placed over the origin that is colored blue using the input device 130 (FIG. 1) or the haptic interface device 120, the processor 105 plays via the audio output device 125, a C-sharp note as sounded on a piano accompanied by the voice clip. This association of graphical and audio parameters that is applied to the surface in essence converts the surface into a virtual instrument that can be played by way of user interaction. Such virtual instruments may include one or more line segments, curves, surfaces, volumes, and/or any subsets or combinations thereof.

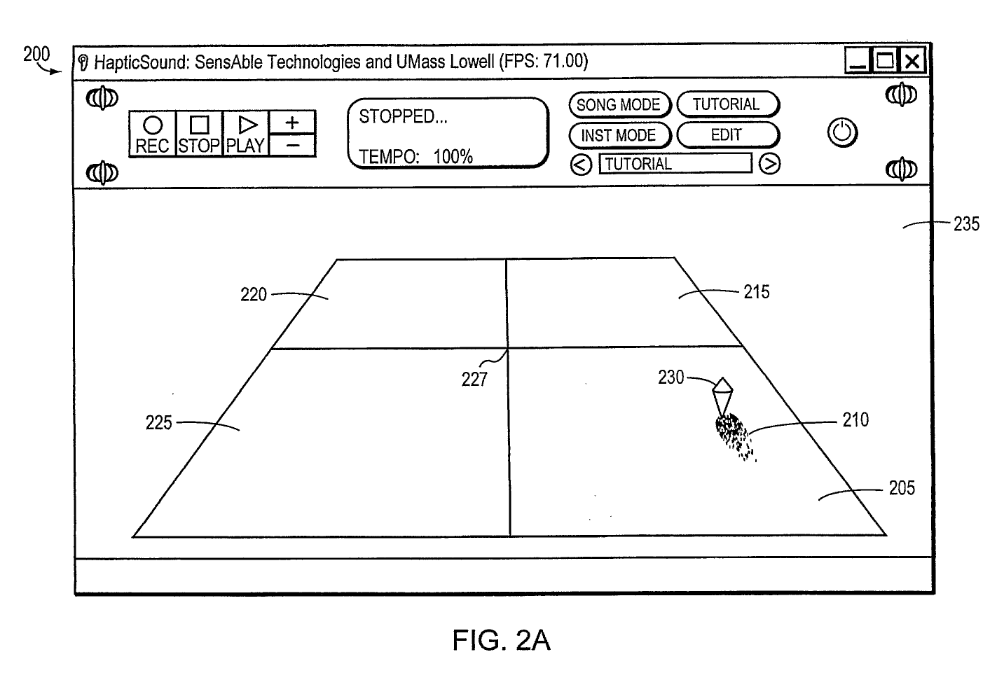

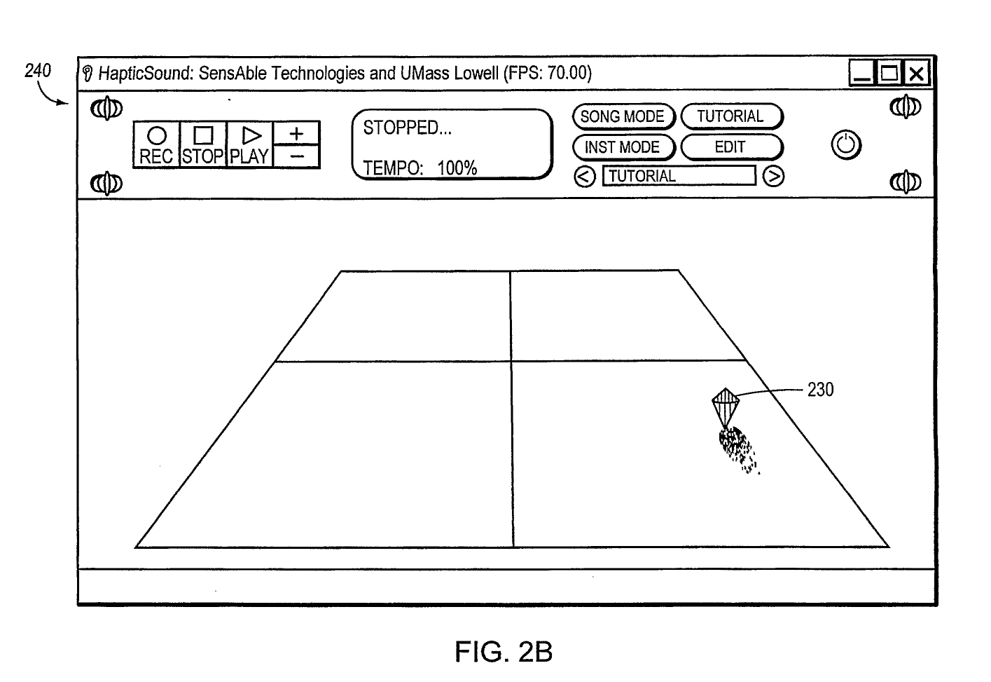

Instruments created in accordance with the disclosed technology can, but need not, correspond to traditional musical instruments, such as pianos, organs, violins, trumpets, saxophones, flutes, drums, and/or other woodwind, brass, string, or percussion instruments. For example, a musical instrument incorporating aspects of the disclosed technology can be a simple surface. FIG. 2A is a screenshot 200 of one embodiment of a virtual musical instrument of this disclosure, comprising a flat two-dimensional surface 205 divided in four quadrants 210, 215, 220 and 225. Each of these quadrants are surface parameters, as they are defined by their x-y coordinate location around the origin 227. In this embodiment, each quadrant is associated with a different musical tone; quadrant 210 is associated with a C, quadrant 215 is associated with a D, quadrant 220 is associated with an E, and quadrant 225 is associated with an F. Thus, if the user places a cursor 230 into quadrant 210, the instrument will play the C, which is the musical parameter associated with the x-y coordinates in quadrant 210. Similarly, if the user places the cursor 230 into quadrant 225, the instrument will play the F, which is the musical parameter associated with the x-y coordinates in quadrant 225. In one embodiment, each quadrant can be a different virtual musical instrument containing tens, hundreds, and perhaps more, x-y coordinate-to-audio-parameter mappings/associations.

In some embodiments, musical parameters and haptic parameters may be associated with each other. One such haptic parameter is pressure, as the user may use a haptic interface device to touch and virtually put pressure on the surface 205 using the cursor 230 as a proxy. In FIG. 2A the user is applying no pressure via the haptic interface device and this no-pressure state is graphically represented on a display device as a white colored cursor of normal size. This no-pressure state is a haptic parameter that may be associated with a particular a musical parameter (e.g., a volume). The user may then raise the volume by increasing, via the haptic interface device, the virtual pressure applied to the surface, as shown in the screenshot of FIG. 2B. The slight red shading and larger size of the same cursor 230 in FIG. 2B graphically indicates that the pressure is higher than that in FIG. 2A. The user may also experience a sensation of higher pressure via the haptic interface device. This haptic parameter of higher pressure may be associated with a proportionally higher volume than that of the note heard in FIG. 2A.

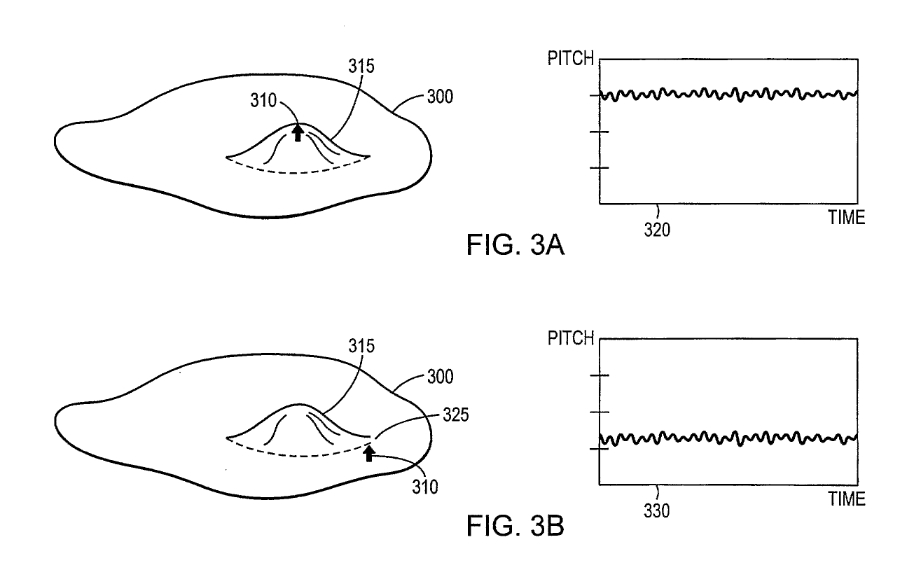

FIG. 3A depicts an illustrative surface 300 where the height parameter of the surface is associated with a pitch of a tone playback. Thus when a cursor 310 is placed on a bump 315 of the surface 300, the pitch of the playback is proportionally high relative to a pitch associated with a lower section of the surface 300, as shown in the graph 320, plotting pitch versus time. Similarly, when the cursor 310 is placed in a valley 325 of the surface 300 as shown in FIG. 3B, the pitch of the playback is proportionally low, as illustrated in the pitch versus time graph 330. Associated musical parameters are by no means limited to volume and pitch and may be, for example, specific musical notes, voice clips, spoken words, sound clips, or some combination thereof, as well as the pitch, tone, volume, duration, frequency, or other audio aspect thereof.

In one embodiment, surface/graphical parameters of a virtual musical instrument are associated with MIDI musical tones or notes (i.e., tones lasting a specified or indeterminate duration), which may be played via an audio output device when a user interacts with the surface. For example, notes may be played when the virtual instrument surface is touched using an input device such as a mouse or keyboard, or a haptic interface device. Such an embodiment may be implemented by defining the virtual instrument, initiating contact with the virtual instrument, determining notes to be played for each MIDI instrument that comprises the virtual instrument, producing the audio output of the notes and producing other MIDI controller value commands mapped to the MIDI instrument.

An audio response/presentation of a virtual instrument can be determined by accessing initialization data (e.g., as may be delineated in a MIDI file or non-MIDI file format) associated with a selected location on a graphical surface of the virtual instrument. Once the initialization data for this virtual instrument is determined for a particular surface location, the MIDI instruments that comprise this virtual instrument are extracted and cycled through based upon the current haptic values sampled at each iteration of a sound thread loop. For each iteration, surface parameter data, such as haptic values from the haptic interface device, surface location data, and color data, are read into a data structure. Corresponding multi-mapping classes are then queried to determine the associated musical parameter values for each MIDI instrument.

On each iteration of the sound thread, a loop of each MIDI instrument contained in the virtual instrument is traversed, producing all the MIDI commands related to the current virtual instrument. Controller values such as pitchbend and modulation are produced when they have been updated. Note events may be produced when a new contact is made with the surface, or the haptic stylus is sliding to a part of the surface associated with a new note. The previous contact may be stored to determine if a new note has been played, and new notes may be triggered if either a new contact has occurred, or contact is present and the stylus has slid to a part of the surface associated with a unique note.

A particular note to be played may be calculated by checking either the scales or song notes specified for each MIDI instrument in the initialization data. In the case of the scales, input haptic values are indexed into the size of the scale array, thereby providing the MIDI notes contained within the desired scale. In the case of song notes, the notes are determined by checking the values of a song mapping array that provides the song notes present at each coordinate on the surface, as determined during the creation of the surface based on the song. If chords are to be played, a particular note may be determined by contact coordinates or other mapped haptic input values. Then the proceeding notes to be played to produce a chord are generated by looking up note offset values in a chord array and adding them to the current note. Initialization data suitable for rendering and performing a virtual musical instrument can be provided in a wide variety of formats and exhibit many differences in content.

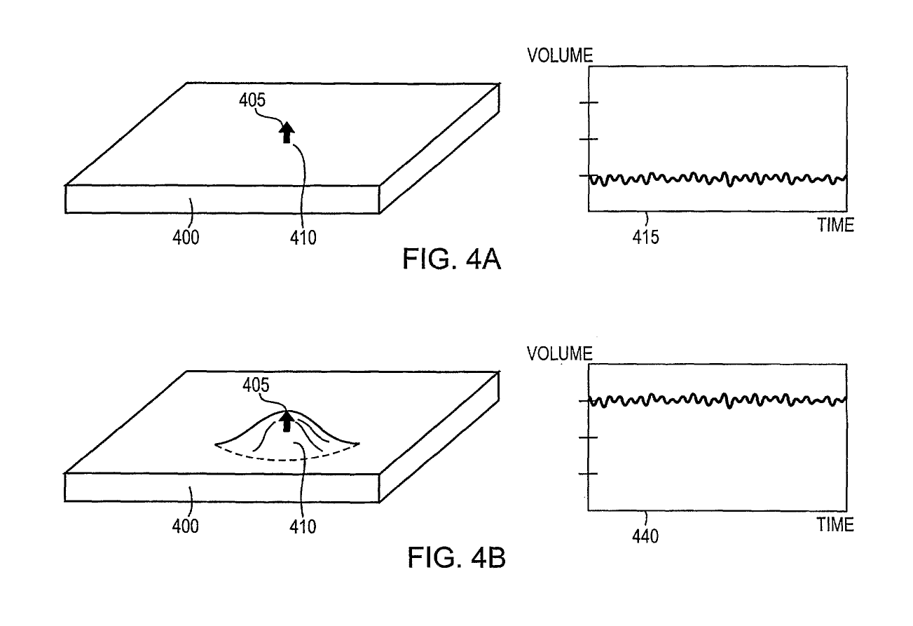

Virtual musical instruments, as represented by rendered graphical surfaces such as those described above, may be modified by a user or software process to create new instruments. FIG. 4A shows a flat surface 400 wherein the height of the surface is associated with the musical parameter of volume. Thus, a cursor 405 placed at a point on the surface 410 results in a first volume, as shown in volume versus time graph 415. If the cursor is placed at other points on the uniform flat surface 410, the first volume would also result as these other points are at the same height as point 410 in FIG. 4A. However, in some embodiments, a user is capable of modifying the surface 400. For example, FIG. 4B illustrates the result of modifying the surface 400 in FIG. 4A to produce a bump at the same point 410. This deformation changes the height of the point 410 and thus a new higher volume is associated with this point, as shown in the volume versus time graph 440. Hence, when the cursor 405 is now placed at the point 410, the volume of the resultant audio is higher than the first volume produced before the deformation. If the cursor is moved to other points along the non-deformed part of the surface, the volume would return to the first volume shown in volume versus time graph 415. Some embodiments permit the user to change a variety of parameters of the surface, such as color, lighting, roughness, and thus change the musical parameters associated with different points on the surface. As such, new virtual instruments may be created.

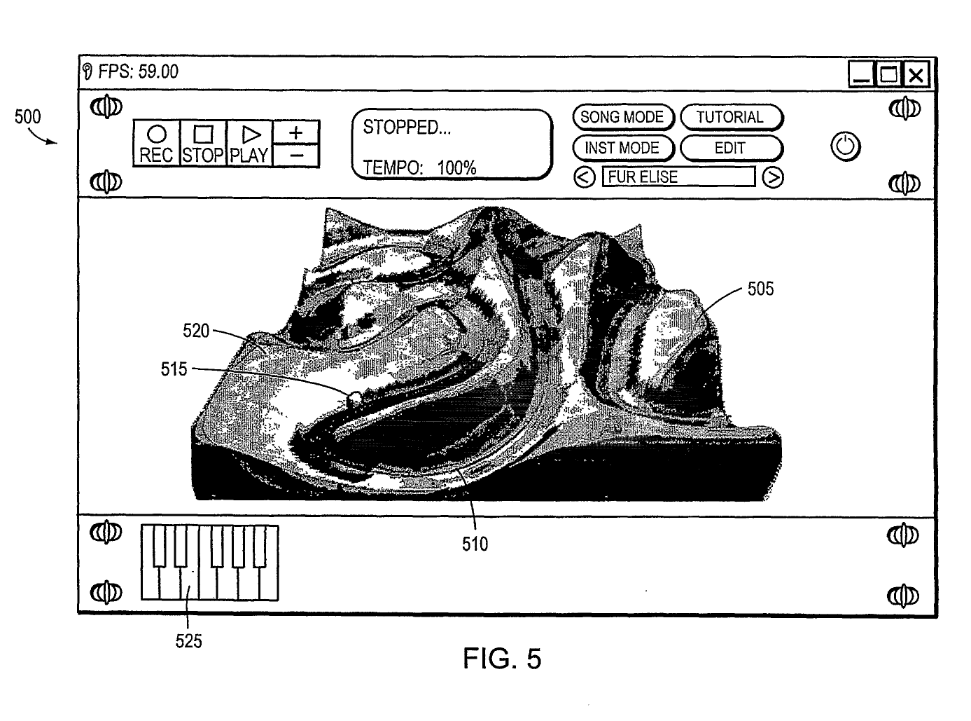

FIG. 5 is a screenshot 500 of an illustrative virtual musical instrument 505 made in accordance with at least some aspects of the disclosed technology. In this embodiment, data representing a song, or a piece of music, may be retrieved and graphically displayed as a curve 510 that traverses through the virtual instrument 505. The coloring below the line may be associated with the notes of a song path as represented by the curve 510. The color variations outside of the curve 510 may be associated with notes that are played when the cursor 515 strays from the song path as represented by the curve 510. In some embodiments, the colors are associated with notes while the shade/lightness of the colors are associated with octaves.

The song may be played linearly (forward), by allowing the cursor 515 to traverse the curve 510, or by moving the cursor along curve 510. Alternatively, a user may move the cursor 515 backwards along the curve 510 to play the song in reverse. Additionally, the user may move the cursor 510 off the curve 515 so as to play musical parameters, such as musical notes, which are not included in the song path. As such, the user may create a new musical composition based on the song represented by curve 510 by moving the cursor 515 off the curve 510 and into other regions of the instrument such as region 520. Such new musical compositions, or songs, may be recorded and played at a later time.

In this embodiment, a surface with three-dimensional hills and valleys is rendered to represent one or more virtual instruments. This surface may be rendered by a variety of mathematical means, including a height map, three-dimensional modeling, carving a surface with a curve, and mathematical functions. Each virtual instrument may be represented by subsets of the surface and may correspond to a size and location within the surface and a priority number to determine which instrument is used/played in the case that one overlaps with another. Furthermore, each virtual instrument may comprise haptic parameters, such as friction, as well as musical parameters, such as those assigned to MIDI instruments. Additionally, virtual instruments may comprise one or more MIDI instruments. For example, haptic and graphical parameters of the virtual instrument may be associated with various MIDI instrument numbers, MIDI channels to send data, musical scales, octave ranges, chord definitions, and modes used to create chords.

Curves representing songs or musical compositions may be initially rendered and then integrated with a surface representing the virtual instrument. Such curves may be initially rendered in two dimensions, represented by points connected with a Bezier curve where every point is assigned an identifier to represent its order of drawing. This curve may then be projected onto the virtual instrument surface, and used to carve out wells within the surface, thereby appearing as a valley traversing through the hills of the instrument surface. For example, the points of the rendered two dimensional curve may initially be projected to three dimensions by adding a height dimension, where each height is initialized at the maximum surface height. In one embodiment, two to five smoothing passes are run on a vector containing the curve points to eliminate most of the jagged edges that can result from two or more points being too close to each other. The result is a smooth curve where the height of all points are at the maximum surface height. Each point is then used to carve a hole/depression into the surface at the point location. Next, between four and six smoothing passes are run on the entire surface and may, for example, involve averaging the height of a point with those of eight neighboring vertices.

In some embodiments, a song curve placed on the surface of the virtual instrument is much like a river winding its way through a series of valleys. Each point on the surface may then be associated with a musical parameter (or sets of parameters, e.g., one set for each instrument active at a particular point), based on the musical parameters in the song. In one embodiment, each point on the surface that is not part of the song curve is traversed. For each point, a calculation is performed to determine which of its neighboring points is the lowest. The disclosed methodology then moves to that lowest neighbor and determines which of its neighbors (not including the path currently being traversed) is lowest, and so on. This is performed until the disclosed methodology reaches the song curve. The path traveled to the song curve is marked as belonging to a note, or other musical parameter, on the song curve that was reached. During the traversal of the surface points, the disclosed methodology skips points that have already been assigned a note from the song curve. The vertical or linear distance from each point on the surface to the note on the song curve may be used to determine the appropriate scales. This method also allows for control of the size of the river bed representing notes around the song path, so that when a user is playing along the song path, without being haptically attached to the song path, the user may still find the right notes. The pitch associated with a given location on the curve is not necessarily a discrete tone in a musical scale but may be, for example, a pitch determined as a continuous function of its distance from the song path.

An alternative to this methodology is where the song curve is not necessarily the lowest point on the surface, but is rather placed on a pre-existing surface. A value of 1 is assigned to each coordinate point the song curve crosses. Next, an iteration is performed over all coordinates, and for coordinates without a value (or a value of “0”), the values assigned to the neighboring coordinate points along with the current coordinate point (which has a value of 0) are averaged, and the average is assigned to the current coordinate point. This step is repeated until no coordinate points have an empty value. This results in a gradient that can be traversed from every coordinate point to the nearest song curve location. Next, similarly to the previous algorithm, an iteration is performed over every coordinate location not part of the song path and the path to the song curve is determined. This method also generalizes to three-dimensional (“three-dimensional”) volumes where the song path is a path traversing a volume.

In some embodiments, techniques can be used to interpolate at a pixel and/or sub-pixel level to identify particular notes to be played and/or to color a surface at a finer resolution than a coordinate grid may support. The methodology described above for creating a gradient can be used for both two-dimensional embodiments and three-dimensional embodiments. In three-dimensional embodiments, the disclosed methodology may be used for rendering volumes and iso-surfaces, allowing for a different look and haptic feel when traversing through the volume and/or when playing/performing the virtual instrument. The disclosed methodology can be applied to multiple song paths on a common volume or surface and would, for example, create areas of the surface based on one song and other areas based on other songs, thereby allowing blending from one song to another when playing the virtual instrument.

The coloring for the song curve may be created by mapping notes in the song to the curve and then representing these mapped notes with different colors. The time duration of each note may be represented on the curve by making the length of the color on the curve proportional to the duration of the note the color represents. Such a representation allows the user to visually gauge/sense the timing in a song. Notes and colors on the curve may be discrete and/or continuous.

Additionally, in some embodiments, the song curve is used as a basis for coloring the surrounding surface, and therefore associating musical parameters such as notes to the surrounding surface. For example, colors may be created for a surrounding surface using a topographical mapping style coloring scheme in which a curve lies at the bottom of a map height wise, and the furthest point from any line along a path is the top of a hill. Other techniques may be used, such as trilinear interpolation followed by any of a variety of filterings and/or smoothings. As a result, the traversing valley in which the curve lies is colored the same as the curve, and the colors begin to change in bands as the height increases away from the band up any hill. This coloration may be based upon some predetermined scale (e.g., based on the notes in an octave that will be played).

When the distance traveled from the curve in the valley and up the hill has exceeded a predetermined height, a new note and hence a new color is associated with that region of the hill, and the coloring algorithm continues up to the top of the hill. These new notes may be chosen in a variety of ways. For example, a new note may be the next note in scale, with a new note created after each set predetermined distance. As a result, for each note on the song curve, the same scale in a different key may be traversed by moving straight up the hill perpendicular to the motion of the curve. Additionally, such a method of choosing the new notes allows for the same song to be played in a different key by following the same song path as represented by the valley, at a standard height along the hills.

In some embodiments, color scales are generated representing a unique color for each note in an octave. These colors may range from a full rainbow effect, having the greatest variety between notes, to a more subtle gradient change between notes. This feature allows for colors to be representative of such psychological attributes as mood and feeling of the music. These colors may be specified as one color for each of the 12 notes in an octave, as well as a color to represent pauses in songs that play no note at all. Colors may be specified in terms of HSL color scales of hue, saturation and luminance. For example, the hue value may be representative of the current note, saturation may be used to further differentiate between similar colors, and luminance may be representative of the octave.

As described above, associated notes may be determined for each location on a surface representing a virtual instrument. These notes may be used as an index to determine the color scale. For example, in an embodiment where the musical parameters are MIDI notes and the surface parameters are surface colors, the MIDI notes may be used as an index into the color scale array by performing a modulus function with a MIDI note, ranging from 0 to 127 in value, thereby resulting in a number from 1 to 12 for each MIDI note. This number is then used as the hue base color for the area on the surface associated with the note. The octave of the note is determined by dividing the MIDI note value by 12 and then taking the integer portion of the division. This octave is then used to lighten or darken the base color depending on the pitch of the note. Thus in this embodiment, each octave has the same color mapping for each note, with the octaves determining the lightness and darkness. Other embodiments may use a different color to represent each octave, with luminance of the hue representing the notes within the octave.

A reverse lookup technique may be used where musical parameters are extracted from surface parameters. For example, the color of an object at a certain point may be compared to the colors in the color scale array to determine which base note the hue represents and which octave the luminance represents. Using such a technique, a representation of a surface may be loaded and used as, for example, height and color maps. Thus for example, a user may load a three-dimensional representation of a face, and the colors on the image may be associated with musical notes via this reverse lookup technique. As such, one can then use the representation of the face as a virtual instrument.

The song curve may also be haptically enabled. For example, in one embodiment, a snap-to line that may be toggled on and off forces the user to stay on the line. This snap-to line may be toggled off if the user applies a threshold force via the haptic interface device. As such, the user may experience a kinesthetic, tactile, or otherwise touch-based sense of following the correct path along the song and is therefore capable of following the standard song path with little effort. In the event that the snap-to feature is toggled off, the user may be then capable of deviation from the song curve and moving along the hills to experience the other musical parameters that have been mapped along the surface.

In some embodiments, the musical parameters of a first instrument are used for coloring versus the generation of the curve. This allows a user to see the notes of one instrument, and hear the notes of all the instruments comprising the surface. Thus the user may conduct one instrument and hear all of them, thus simultaneously playing an instrument in an orchestra setting. For example, if the notes of a rhythmic part of a song were used for the song, the other notes of the song would follow as the user conducted through these notes, emphasizing the rhythm of the song. Similarly, the melody of the song could be used and all other instruments would follow the progression of these notes as a leader. This method is useful for learning rhythm and other music basics. In certain embodiments, an orchestra score may be haptically rendered using one or more virtual musical interfaces.

This method may also be modified to work within a three-dimensional space to determine the amplitude/height of the hills on which a winding song curve could fall. For example, long notes may correspond to tall hills, producing the experience of holding a note for a long time. Similarly, short notes would correspond to small hills, producing the feeling of short and fast notes that occur more quickly than other notes. Thus the height of the surface may provide a visual and haptic indication of the progression of the song. The user may thus both see and feel the length of notes, thus enhancing the interactive nature of the experience.

In some embodiments, a display screen displays both the virtual musical instrument 505 (FIG. 5) and a color coded keyboard 525 that displays the colors associated with each note. This color coded keyboard 525 may be modified and assigned to any surface representing a musical instrument. As a user moves along the surface of the virtual musical instrument, the keyboard note associated with the point on the surface the user is currently traversing may be highlighted.

In some embodiments, there are two or more virtual instruments that may overlap. A subset of each virtual instrument in these embodiments may have a priority associated with it that enables it to be visible over the others. Additionally, a transparency value may be assigned to each overlapping virtual instrument, allowing those with lower priority to play through as well. Where there are overlapping instruments with assigned transparency values, the instruments with lower priority may be played with attenuated musical parameters. This layering of virtual instruments allows for complex virtual instrument surfaces to be created, with patches within larger virtual instruments specifying variation instruments similar to the larger virtual instrument, or entirely independent instruments. Layering supports blending between layers that are hidden using pressure, for example. When more pressure is applied via the haptic interface device, the lower priority instruments may begin to fade in when they were silent before. The user may thus feel an effect of burrowing into other instruments and to hear these other instruments fade in as more and more pressure is applied.

In one embodiment a subset of the surface parameters are associated with musical parameters while the remaining surface parameters are unassociated. Thus, in this embodiment, part of the surface may be played by the user while other parts of the surface cannot be played. An example of this embodiment is a virtual piano whereby the keys can be played but the wooden casing of the piano cannot be played. In one embodiment, a “haptic hanger” is among the parts or the surface that cannot be played. The hanger may serve as a virtual “parking space” at which a haptic interface device may be placed when not in use, so as to prevent inadvertent modification of and/or interference with a musical composition as it is being performed.

In some embodiments, more than one surface parameter may be associated with a single musical parameter. Furthermore, each surface parameter may affect the musical parameters with varying magnitude. For example, the position of a gimbal on the haptic interface device may correspond to a maximum in the musical parameter of volume when the gimbal is positioned at half its maximum position along the z-coordinate, and to minimum volume when the gimbal is positioned at its minimum position on the z-axis or at its maximum position on the z-axis. This flexibility in how the surface parameters map to the musical parameters allow for complex mapping such as cross-fading between two instruments, where one instrument may have its maximum volume when the other has its minimum volume.

In some embodiments, association of surface parameters with musical parameters is in the form of haptic parameters of the surface of the virtual instrument being associated with or mapped to MIDI sound control output parameters. In such embodiments, a class structure may be designed to incorporate all of the mapping possibilities, which may sometimes include extremely complex mappings. One or more haptic input values may be used to modify one or more MIDI output values. For example, each haptic input value including, for example, a gimbal location, a pressure button state, and a stylus button state, may return floating point values from 0 to 1. These haptic input values are then translated into values of 0 to 127, recognizable by the MIDI controls through a series of filtering functions.

These filters may include initial haptic value translations, providing alterations to the 0 to 1 haptic values. The filters may also include a minimum and maximum sensitivity, thus altering the growth rate of the haptic values. The filters may further comprise a center point determining where 0 falls through the haptic input values, thereby allowing inverse transitions of the values. These filers may also comprise haptic mixing algorithms that determine how multiple haptic values get mixed together. Such haptic mixing algorithms may comprise functions such as average, addition, multiplication, offset from a base using a secondary haptic interface value, and the minimum and maximum change to the MIDI value parameter within the MIDI range. For example, the average function adds all the haptic values and scales the result within the full minimum and maximum values of a standard haptic parameter. The multiplication function works in a similar manner with the haptic values being multiplied and then scaled. The offset function allows a base haptic control to be chosen, while a secondary haptic control contributes to a displacement from that base control's haptic value. As such, the base control may return a value based upon its haptic input, and the secondary controller may cause a variation from this current value based upon its haptic input. This allows for multiple haptic parameters to be used, for example, to cause a deviation from a base line that progresses in value, such as deviating from a path and changing the current value on the path. This multi-mapping structure allows for many surface parameters to affect many musical parameters, thus allowing for relatively complex routing of input data.

The haptic sensitivity may be used for gimbal controls, where the amount of twisting required to reach a maximum is a desired variable, allowing more subtle twists to produce the same effect as twisting the entire range of the haptic control. The center point of a haptic interface control allows for either inverted ranges of the control, such as going from 1 to 0 rather than 0 to 1. Alternatively it may be possible for the center of a gimbal to return 0 rather than 0.5.

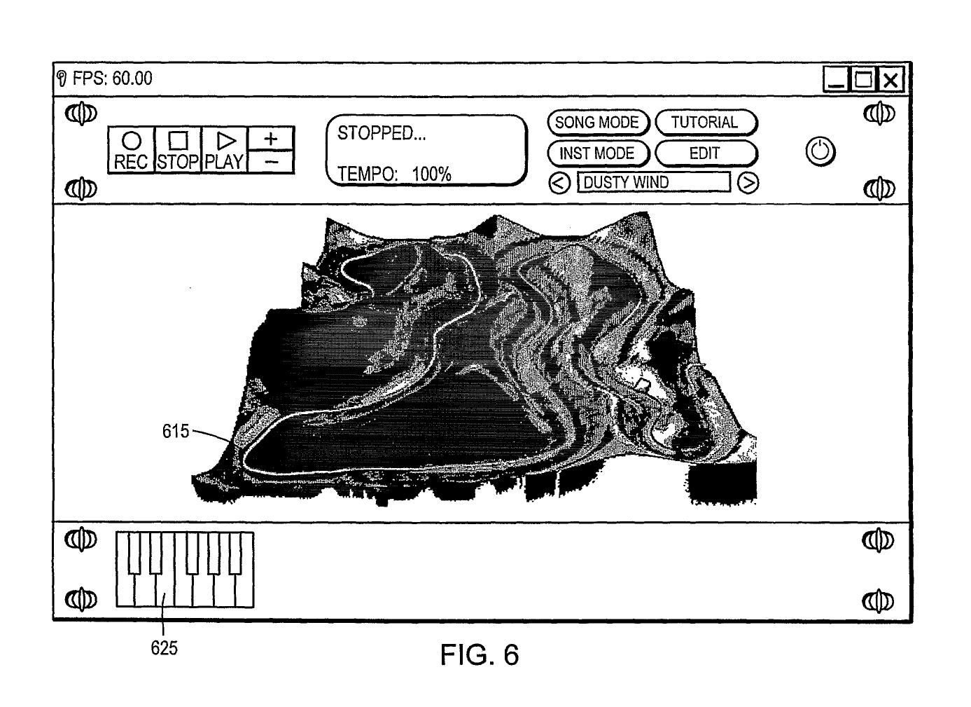

FIG. 6 is a screenshot of a virtual musical instrument using an alternate color scheme and an alternate surface relative to that of the FIG. 5 virtual instrument. However, the song represented by the curve 615 is the same song as that represented by the curve 515 in FIG. 5. Since the surface shape and color of associated notes are different in the FIG. 6 embodiment as compared with those of the FIG. 5 embodiment, the shape of the curves 515 and 615 representing the same song are also different. In this embodiment, the color coded keyboard 625 displays notes and their associated colors.

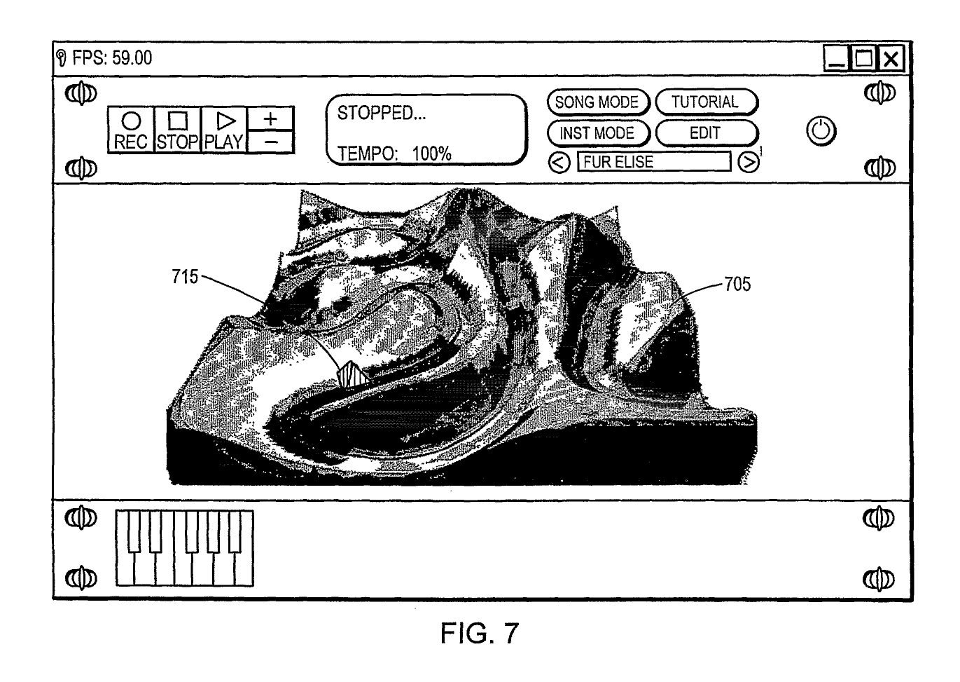

FIG. 7 is a screenshot displaying a surface 705 of a virtual musical instrument, which is identical to the surface 505 of the virtual musical instrument shown in FIG. 5. However, in the FIG. 7 embodiment, the haptic parameter of pressure, as applied by a user via a haptic interface device, is also associated with musical parameters, such as pitch. Thus, for example, as the pressure is increased the pitch of the playback sound increases. This particular screenshot shows the display when the pressure is as applied by the user is high. The cursor 715, which is normally white and standard sized, is in this screenshot red and larger, representing the high pressure.

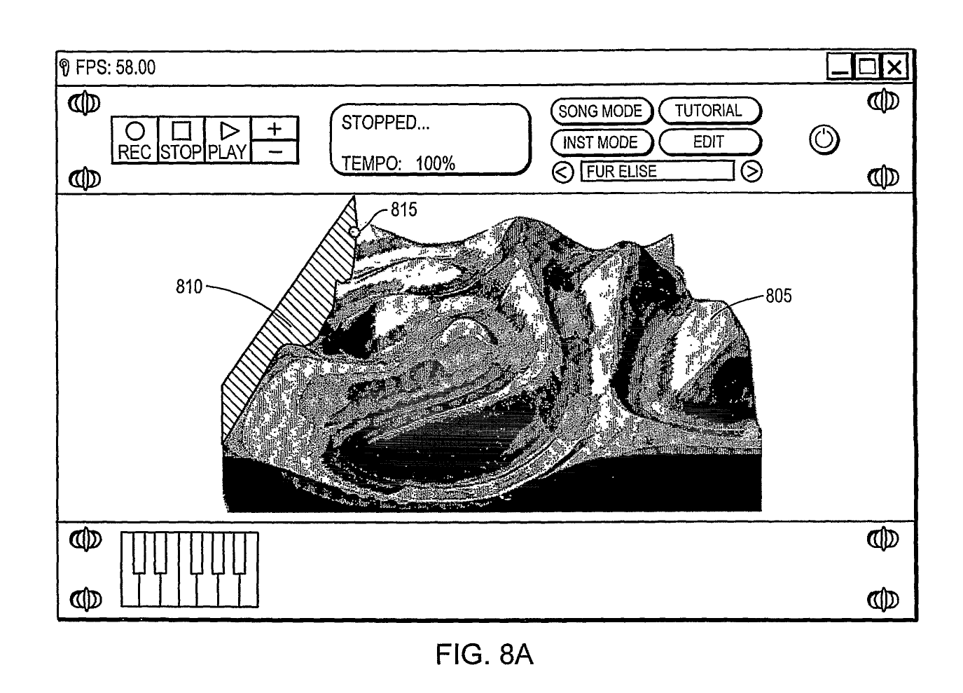

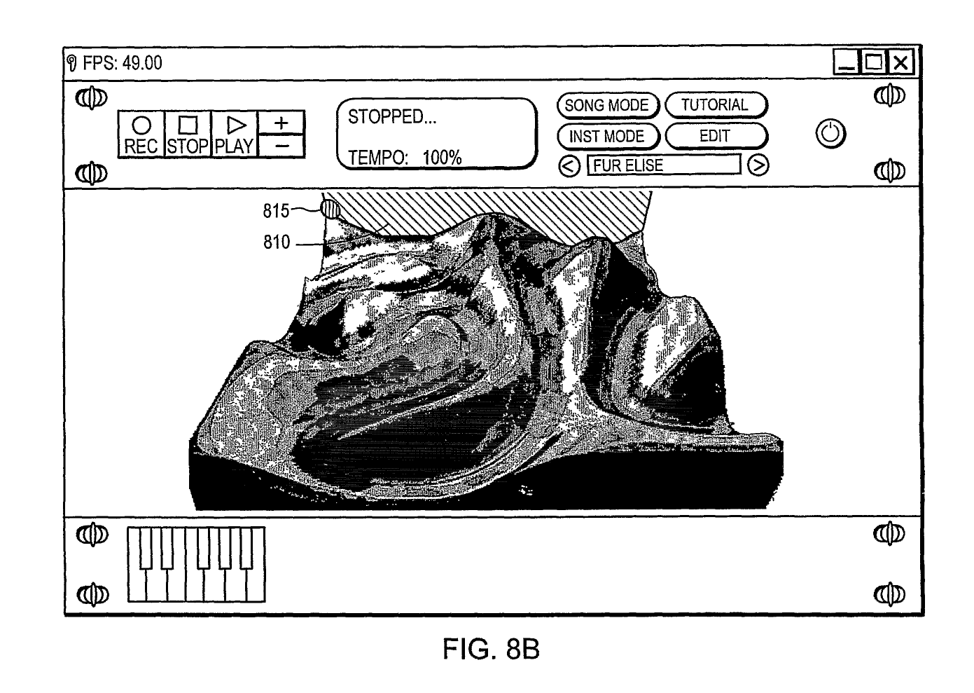

FIG. 8A shows a screenshot of a virtual musical instrument with a haptic boundary as represented by a virtual wall 810 stopping travel of the cursor off the surface. This virtual wall 810 is normally translucent, and begins shading up from black to full green as the pressure from the cursor is increased. FIG. 8A shows a situation where the cursor 815 has just touched the virtual wall, and so the virtual wall 810 is dark green and the cursor is normal sized and white, representing little or no pressure. FIG. 8B is a screenshot showing the situation where the user applied more pressure via the haptic device, so increasing the virtual pressure of the cursor 815 on the wall 810. As such, the color of the virtual wall 810 shades up to full green, and the cursor 810 is large and bright red, both representing high pressure situations. The act of touching the virtual wall 810 with the cursor 815 may be associated with a musical parameter, such as a particular note. Additionally, the haptic parameter of pressure by the cursor 815 against the virtual wall 810 may also be associated with a musical parameter.

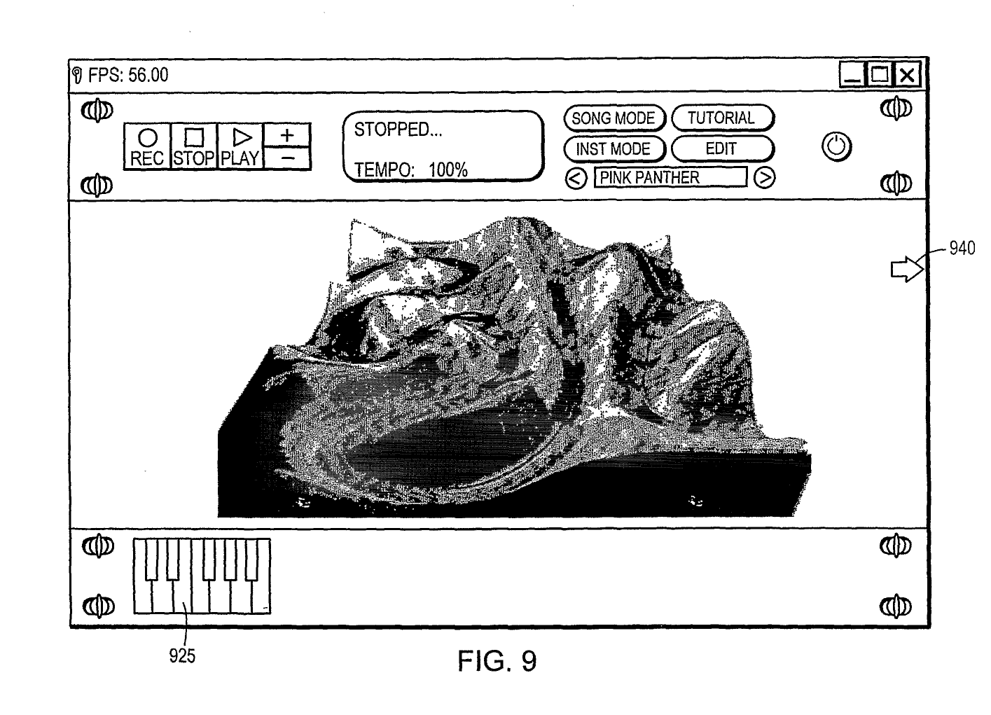

FIG. 9 is a screenshot of the virtual musical instrument of FIG. 5 where different colors represent different musical parameters. The color-coded keyboard 925 displays the color associated with each note. The yellow arrow 940 represents a situation where the cursor has left the screen coordinates. In this case the user may feel a haptic wall stopping motion past the coordinates viewable on the screen, and thus in the yellow arrow 940 is displayed to indicate the location of the cursor.

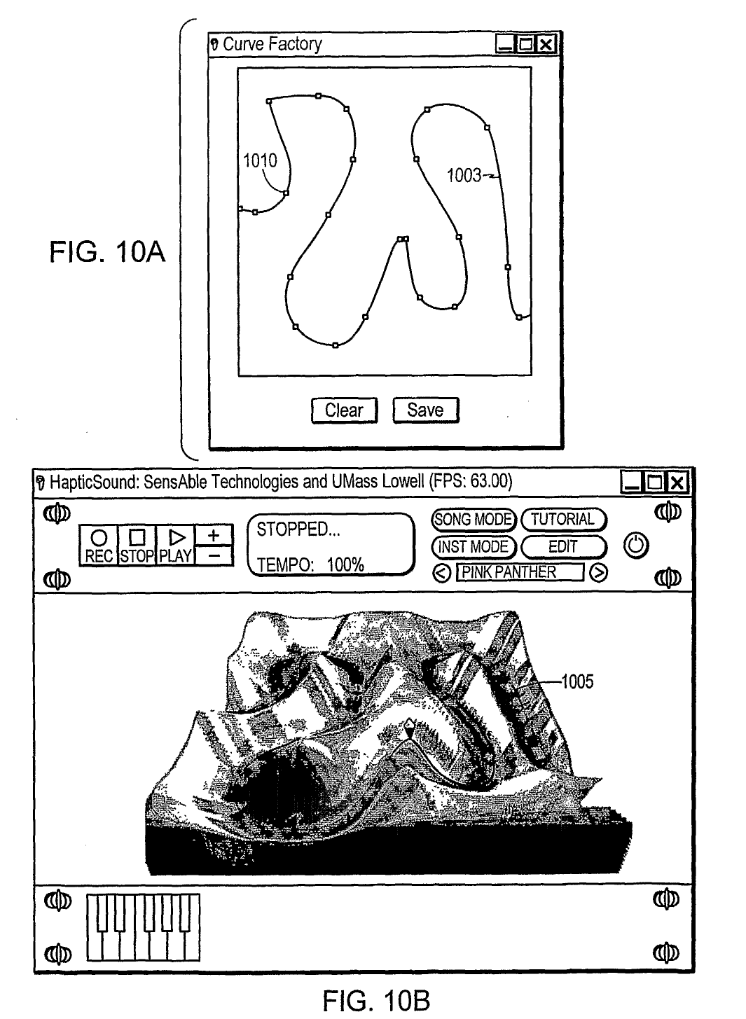

FIGS. 10A and 10B illustrate how a song curve may be calculated. First, the musical parameters of the song are calculated and represented by points such as point 1003 in FIG. 10A. These points are then connected together as Bezier Splines, forming a curve 1010 that traverses through each musical parameter in the song in the correct order in time. The curve 1010 is then transformed into a smooth three dimensional surface and overlaid on the instrument as shown in FIG. 10B. Each point 1003 is matched up with an identical or similar musical parameter on the instrument 1005.

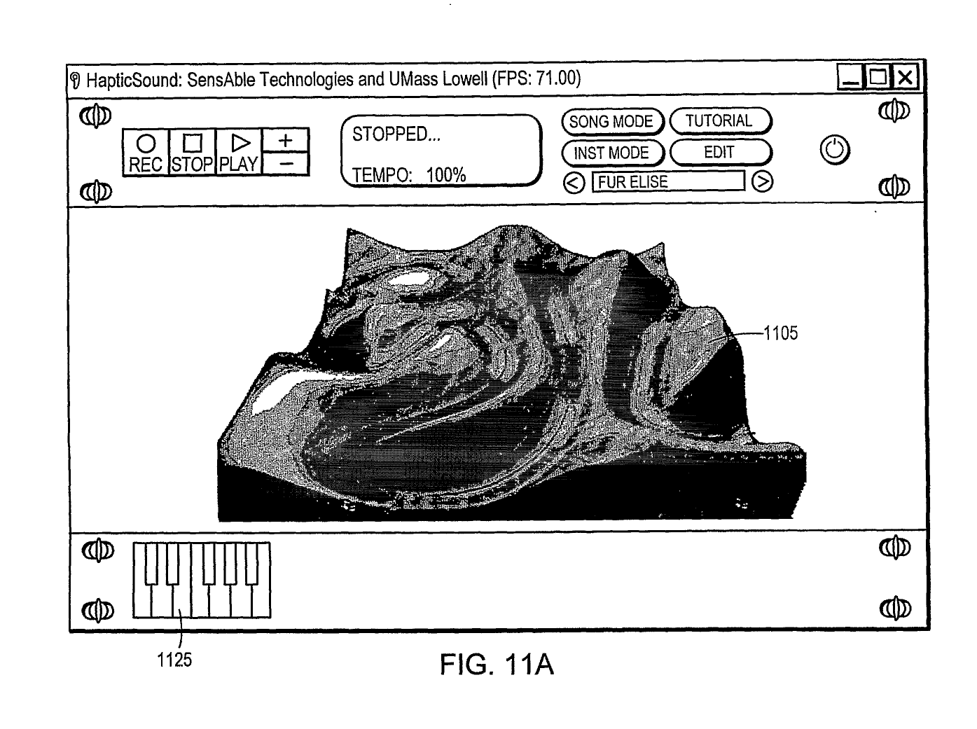

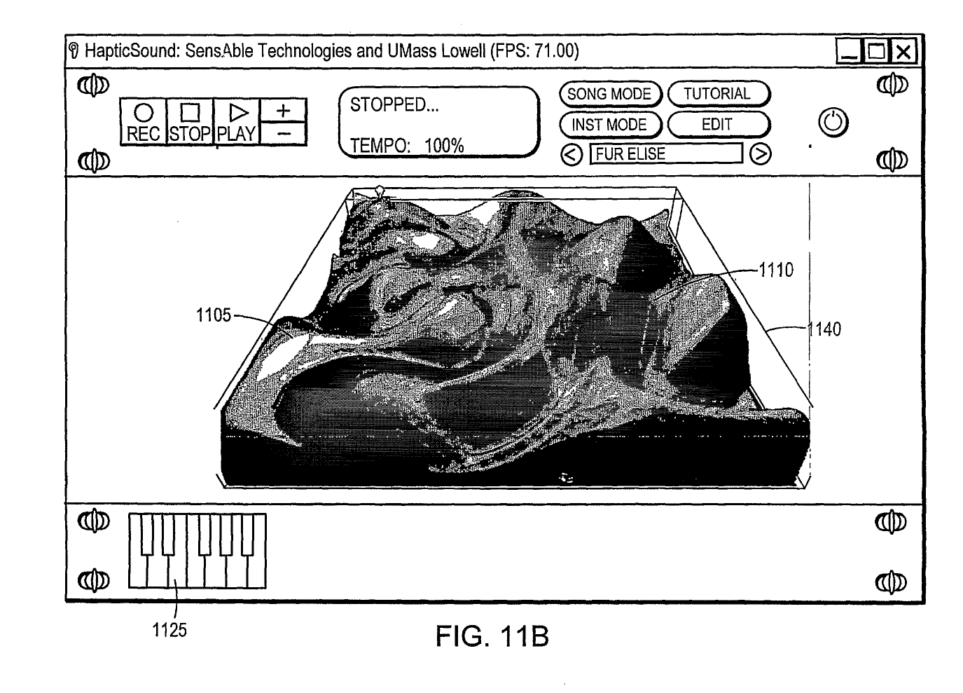

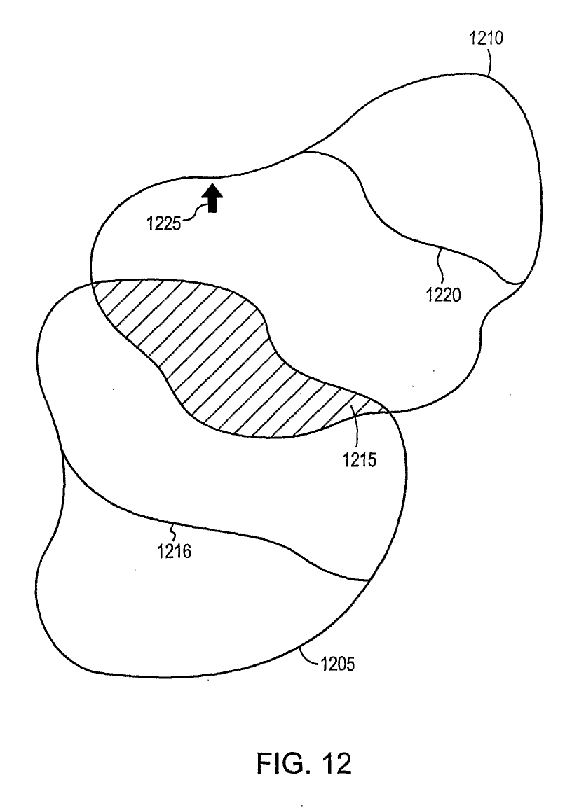

FIG. 11A is a screenshot of a three dimensional surface 1105 representing a virtual musical instrument. The colors on the surface 1105 may represent musical parameters, such as different musical notes. The color coded keyboard 1125 shows association between the colors and the notes. In this embodiment, the user may edit the instrument by deforming the surface 1105. FIG. 11B shows the surface 1105 after editing by a user, adding bumps and valleys. The song curve 1110 adapts to this edited surface by morphing to the new bumps introduced to the surface. FIG. 11B also shows a wire frame bounding box 1140 which highlights the workspace and guides the user for easier surface manipulation when editing the surface 1105.

FIG. 12 is another embodiment of a virtual musical instrument. In this case, the instrument is represented by two surfaces 1205 and 1210, interconnecting at region 1215. A song 1216 may be played on surface 1205, while a song 1220 may be played on surface 1210. The associated musical parameters associated with these surfaces may be arranged so that when the cursor 1225 moves off the lines representing songs, the audio heard by the user is similar to the song, varying slightly. As such, each surface may be associated with a song, thus allowing the user to veer off the curves 1216 and 1220, and so create variations of these songs. If the user places the cursor in the region 1215, the audio heard would be a combination of the two songs. In an embodiment in which two or more surfaces substantially overlap, corresponding songs can be played synchronously.

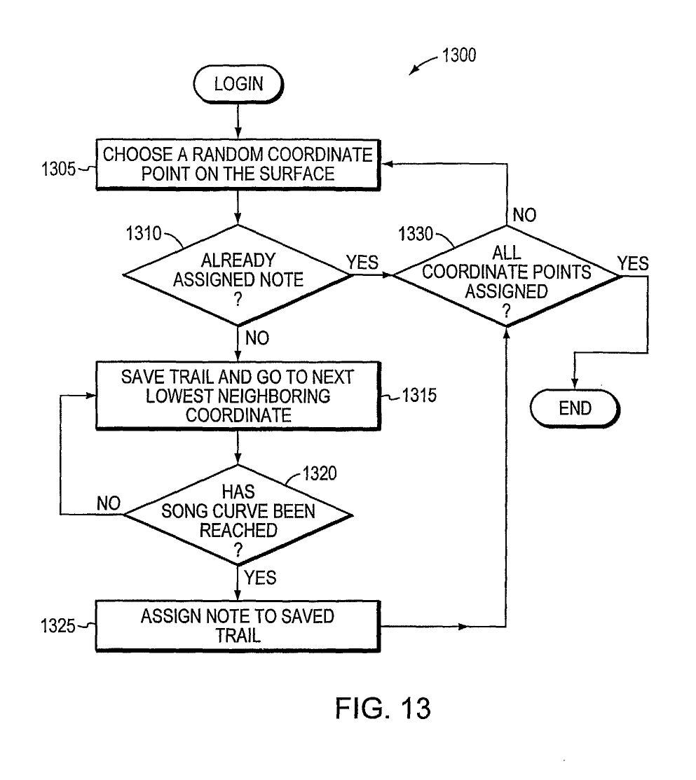

FIG. 13 is a flowchart illustrating an exemplary algorithm for associating musical notes to each coordinate of the surface of a virtual instrument. The association algorithm in this embodiment is based on a song curve that has been integrated with the instrument surface as described above. Hence, the coordinates of the song curve have been associated with musical notes representing the song and/or with audio parameters originating from each of the virtual instruments making up the song. This algorithm may be applied to associate musical notes to the sections of the virtual instrument surface that are not on the song curve. Additionally, this algorithm is not limited to associating musical notes with surface coordinates, as it may be generalized to associate any musical parameter or set of musical parameters to any surface parameter. The disclosed technology can also provide algorithms that associate musical/audio/sound parameters or sets of such parameters to surface parameters of a virtual instrument where there is no pre-existing song curve or musical composition. For example, an illustrative algorithm may select a coordinate location on a virtual instrument surface and, if the selected location has not already been assigned a musical parameter, the algorithm can associate a musical/audio/sound parameter or set of such parameters with the coordinate location, and/or with the graphical and haptic parameters of that location. The algorithm can be repeated until substantially all coordinate locations are associated with musical/audio/sound parameters.

The first step in the algorithm is to choose a random coordinate point on the surface of the virtual musical instrument 1305. A determination is made as to whether this chosen point has already been assigned a note 1310. If it has not been assigned a note, then the algorithm traverses to the lowest coordinate point neighboring the chosen coordinate point, and the trail is saved 1315. Next, a determination is made as to whether this next coordinate point is on the song curve 1320. If the point is not on the song curve, block 1315 is then repeated, traversing to the lowest coordinate point with respect to this current coordinate point, not including the point previously traversed. If the current coordinate point is indeed on the song curve, then the particular musical note on the song curve that is reached is assigned to all the coordinate points on the saved trail 1325. In some embodiments, the musical scale of a point may be determined based on the distance the coordinate point is from the curve. Next, a check is done to determine if all coordinate points have been assigned a note 1330. If yes, then the algorithm ends and the mapping of each coordinate point to a note is saved. If no, then another coordinate point is chosen at random in block 1305, and the process continues until all coordinate points have been assigned musical notes. In block 1310, if the coordinate point has already been assigned a note, then the test in block 1330 is performed to determine if substantially all coordinate points have been assigned notes. If yes, then the algorithm ends, and if not then another coordinate point is chosen in block 1305, and the process continues until all coordinate points have been assigned notes.

The algorithm in FIG. 13 creates a mapping of coordinate points on the surface of the virtual instrument to musical notes. These mappings may be used to determine the coloring of the surface, as described above. Furthermore, these coloring tables and mappings may also be used to create a virtual instrument from a random image by reverse mapping from the colors on the image to the associated notes.

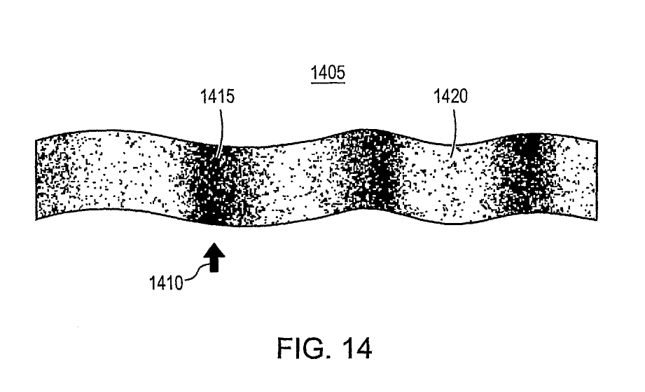

FIG. 14 shows a graphical view of a song playback represented by a colored stream 1405, according to certain embodiments of the invention. Different colors on the stream represent different musical parameters. For example, in one embodiment, a marker 1410 may traverse the colored stream 1405, and musical parameters associated with the color of the current marker position are played. For example, in one embodiment the color black may be associated with C-sharp, and the color white may be associated with F. Hence, when the marker 1410 is positioned at the color black at point 1415, C-sharp is played. Similarly, when the marker 1410 is positioned at the color white at point 1420, F is played.

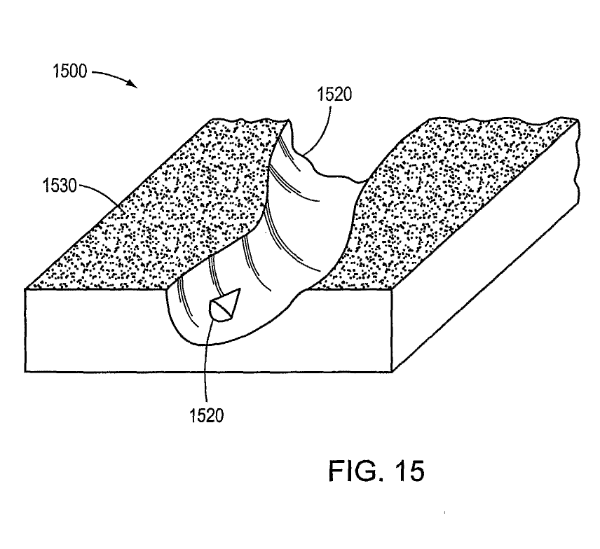

FIG. 15 shows a virtual musical instrument 1500 in accordance with one embodiment of the invention, where the user views the instrument from the point of view of the cursor 1510. Thus the user may experience flying through the curves, hills, and valleys 1520 of the surface 1530 that represents the virtual musical instrument. The user may direct the cursor down different paths and routes, thus playing different musical parameters, depending on the choice of path.

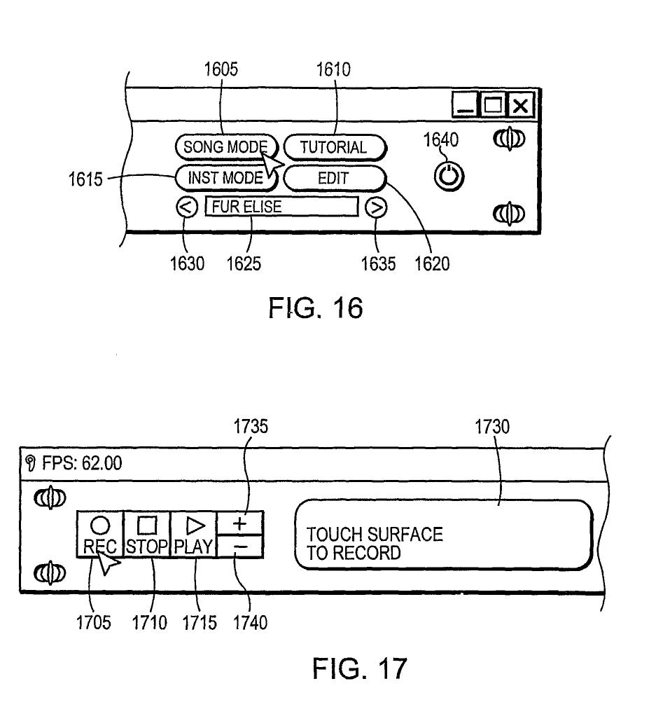

FIG. 16 displays a screenshot of a graphical user interface (GUI) control of the present disclosure. The buttons 1605, 1610, 1615, and 1620 are provided to switch between modes of operation. For example, the user may select button 1605 to activate a song mode, which allows for the display of saved songs as curves on an instrument, or alternatively, creating and saving songs by interacting with the instrument. Button 1610 activates a tutorial mode, which instructs a user in using and interacting with the interface and the virtual musical instruments. Button 1615 activates an instrument mode, allowing the user to edit and save instruments, as well as, load and create new instruments. Button 1620 allows for editing in each of the above-described modes. The name of a current song or instrument may be displayed in box 1625. Buttons 1630 and 1635 on the sides of box 1625 allow a user to switch between different songs or instruments. Finally, button 1640 is highlighted to indicate when an application is executing using a standard power symbol.

FIG. 17 illustrates illustrative GUI controls used for playback and recording. A user may select a record button 1705 to record a musical piece that is played on a current virtual musical instrument. For example, when the user selects record button 1705, the button changes from white to red to indicate that recording has commenced. Message box 1730 may indicate that the user should touch the surface of the instrument to begin recording a musical piece. Recording may start when contact is first made with the surface of an instrument. The user may select a play button 1715 to play a recorded musical piece and may select a stop button 1710 to terminate play or record modes. “Plus” button 1735 and “minus” button 1740 can be used to change a tempo, with the plus button 1735 indicating an increase in tempo, or speed of playback, and the minus button 1740 indicating a decrease in tempo. Message box 1730 may indicate the percentage value of a tempo, with 100% indicating regular speed.

In one embodiment, an application programming interface (API) is provided to allow for the creation and rendering of a virtual instrument and for the manipulation of the instrument's static and/or interrelated parameters. For example, general functions using arguments that are preferably named in a manner to facilitate their purpose can be used to enable the mapping, setup and playback of audio and may thus be incorporated into a haptic-enabled MIDI toolkit. This enhanced toolkit would therefore facilitate the creation, modification, and maintenance of audio or multimedia environments using volumetric surfaces for haptic developers, audio application designers, game developers, and other interested parties.

In some embodiments, song curves, instrument definitions and other sound mappings may be placed on all sides of a volume, providing greater flexibility than a single surface of variable height. Such volumetric surfaces may also be molded and shaped into surfaces that can be more specifically tailored to a user's applications. Such embodiments might be used by game developers to specify characters and objects on which sound may be mapped. This can also allow for abstract designs of multitrack song curves that span multiple dimensions and may be intuitive and useful for musical creation and modification. For example, sound parameters may be mapped to a suit of armor in a game, such that when the armor is touched (by, for example, a sword strike) it sounds like the metallic clang a suit of armor would typically make.

Although the disclosed technology has been described as being operable on two or three-dimensional surfaces, those skilled in the art will recognize that many additional applications of the disclosed technology can be implemented. For example, a virtual instrument can be played by navigating through a volume of the instrument, where each three-dimensional coordinate point may be associated with a musical parameter, such as a note and the position of a cursor in the three-dimensional coordinate system may play the associated note. Those skilled in the art will further recognize that the teachings of the disclosed technology are not limited to the musical arts and can be beneficially applied to substantially any type of application/environment involving sound and/or other type of sensory applications or environments.

At least some aspects of the disclosed technology may be found in the HapticSound product produced by SensAble Technologies, Inc. of Woburn Mass. A number of aspects and/or illustrative embodiments of the disclosed technology are described herein.

In one embodiment of the invention, haptic parameters including pressure, velocity, colors of objects at specific coordinates, and/or movement of the haptic device are mapped to substantially any MIDI parameter, including pitch, volume, aftertouch, and continuous controllers. More than one haptic parameter may be set to modify a single MIDI parameter, each having options as to how they affect the MIDI control.

These options may include the amount of effect the control has in terms of a minimum and maximum, the sensitivity of the control in terms of how quickly the values returned change from the minimum to maximum, where the minimum of the control lies and the method in which a combination of haptic controls affect the MIDI parameter. The location of the minimum of the control may allow the controller to work as it normally does, returning its minimum or maximum at its normal minimum or maximum locations, or to work in other ways such as having the minimum in the middle of its movement, at the end of its movement, or anywhere in between. This may allow the minimum value to be, for example, in the central position of a gimbal arm on a haptic interface device, with the maximum reached in any direction away from that point, or at the end of movement, effectively switching the direction that the control grows, putting the maximum value at the normal location of the minimum and the minimum where the maximum normally lies. This may allow for complex mapping such as crossfading between instruments, in which one instrument has its maximum volume where the other has its minimum, and vice versa, with the middle location between the two at 50% volume for each.

The method in which multiple haptic controls are treated when mapped to a single MIDI parameter can determine how several controls, returning continuous controls ranging from their minimum to maximum, are mixed with one another, producing the final MIDI control value output. Any method of combination of controls may be used. For example, methods that may be used include average, product, and offset. Averaging takes the values, adds them up, then scales them to range within the full minimum and maximum of a standard haptic parameter when treated solely. Product works in a similar manner, with the values being multiplied then scaled, rather than added. Offset allows a base haptic control to be chosen, making the secondary haptic control contribute to a displacement from that base control's value. This means that the base control can return a value based upon its haptic input, and the secondary controller can cause a variation from this current value based upon its haptic input. This may allow multiple haptic parameters to be used, for example, to cause a deviation from a base line that progresses in value, such as deviating from a path and changing the current value on the path, as is the case with the song notes deviating from the current note in the song within the song mode of the disclosed technology. This multi-mapping structure, allowing many haptic parameters to affect many MIDI parameters, can allow for complex routing of input data with fairly little effort.

In some embodiments of the invention, smooth curves that flow along a planar surface with height contours are supported by the disclosed technology. These curves may be created externally and imported into the disclosed technology to define the song curve. Curves may be arbitrary; for example they may be C0, C1, C2 or of higher order continuity. The smooth (C2) curves may be created using a program such as, but not limited to, a Java program. Once the curve is created, it may be placed on the surface, its points and point orders may be retained for further calculations, and it may be used to carve out depressions within the full surface around it, producing a curve which appears as a valley among many hills of varying height. This may produce an aesthetically pleasing surface with a song that progresses along the winding path, once the song is mapped to the curve.

In one example embodiment of the invention, the coloring for the song curve is created through a mapping of notes to the curve. In one example, a midi instrument's song notes track data within an initialization file, an .ini file, or in code, such that the coloring becomes a function of that particular track. The colors can be placed along the curve by going through each incremental integer value point (to get discrete notes in general, with continuous notes also possible) on the curve and using the distance traversed on the curve to index into the song notes, look up the current song note, and color the surface based upon the color scale chosen, as described below. The durations of each note may then be determined using the length of a particular color on the curve, giving the user an idea of what kind of timing to expect along the path.

Using this song curve data in one example embodiment, the colors may be created for the underlying surface using a topographical mapping style coloring scheme in which the curve lies at the bottom of the map height wise, and the furthest point from any line along a path is the top of a hill, or some other techniques such as trilinear interpolation followed by various smoothings. In other words, the valley that the curve lies within can be colored the same as the curve, and the colors can begin to change in bands as the height increases away from the band up any hill. This coloration can be based upon a scale chosen in the initialization file that determines what notes in an octave will be played. As the distance traveled from the line up the hill has exceeded a set height, a threshold, a new note and consequential color can exist, with this pattern continuing up to the top of the hill.

In an example embodiment, these notes may be chosen in various ways, such as by taking the current song note and adding to it the distance to the next note in the scale. This means that for each note, the same scale in a different key can be traversed by simply moving straight up the hill perpendicular to the motion of the curve. This also means that the same song can be played in a different key if the same song path is followed at a particular height along the hills. The colors may also reflect this fact since the topographical mapping can produce banding that represents the curve decreasing in size as it travels up the hill.

In certain example embodiments, the song curve may also be haptically enabled as a snap-to curve that forces the user to stick to the curve unless this is toggled off by use of an appropriate control, such as, but not limited to, a button on a haptic interface device, or when a threshold force is applied to the haptic interface device. This means that the user can feel a sense of following the correct path, and is capable of following the standard path with very little effort, allowing comfortable song playback with the associated haptic feelings. Once the user is comfortable with this, snapping can be turned off, and while the song can still be played along the colors representative of the song curve below the song curve, the user is then capable of deviation from the path and moving along the hills to hear the other sounds that have been mapped along the surface.

In some embodiments of the invention, a song placed on a path can be thought of as a river (located at the lowest point in a valley) wending its way through a series of valleys. A grid can be placed over the whole surface and the x, y and z value at each grid point determined. The grid points that are not part of the song can be traversed through, and after determining which of its neighbors are the lowest, that neighbor can be followed to see which of its neighbor's (not including the path currently being traversed) is lowest. This process can be followed until the song curve (associated with the lowest point in the valley) is reached. The user may also control the size of the valley (corresponding to the notes around the song path) so that when a user is playing the path, without being haptically attached to it, the user can still find the right notes. In an alternative embodiment of the invention, the method may be used with a surface where it cannot be guaranteed that the song curve is the lowest point on the surface.

In certain embodiments, the use of a grid may be limiting, but Graphics Processing Unit (GPU) techniques may be used to interpolate at a subpixel level to determine which notes should be played and to color the surface at a finer resolution than the resolution of the grid. The methods above for curves on surfaces may be generalized to three-dimensional volumes where the song path is a path traversing that volume. Methods for creating a gradient within these volumes may be useful for both two-dimensional and three-dimensional cases. The methods may be used for volume rendering, and iso-surfaces may be rendered, allowing for a different look and haptic feel when traversing through the volume. The algorithm may also support multiple song paths existing both on the same surface and in the same volume. Areas and volumes produced by these algorithms may produce a blend from one song to another when playing a virtual instrument.

In another example embodiment of the invention, a data specification may be located in small text files that is easily editable and loadable during the life of the program. Each file can be parsed and translated into the correct data for use in creating a virtual instrument surface each time the file is loaded. These files may be text-based, but in an alternative embodiment, need not be. In certain embodiments, these files may include flags that specify the data that follows, making the files readable and easily editable by someone familiar with the functions and names of the parameters used in an application.

One example embodiment of the invention includes a virtual studio containing a virtual musical interface that may contain one or more virtual instruments, allowing a single virtual musical interface to contain, for example, multiple MIDI instruments. Virtual instruments may be represented as playable curves, surfaces and/or volumes. A single virtual musical interface may contain multiple, and possibly overlapping, virtual instruments. Each individual virtual instrument within the virtual musical interface may have a priority associated with it, allowing parameters associated with virtual instruments to be set according to the instruments priority. For example, in some embodiments, a virtual instrument of a higher priority my have a higher volume, or be more visible in the virtual instrument surface. A transparency value may also be used on a virtual instrument, allowing instruments with lower priority play as well while possibly being attenuated in some other way. Each virtual instrument may have multiple MIDI instruments, or voices, associated with it. For each MIDI instrument a separate mapping of haptic and location parameters to MIDI parameters can be applied.

In another example embodiment, the disclosed technology includes an instrument surface as defined by a planar surface with three-dimensional hills and valleys. This surface may be created by substantially any mathematical means, such as, but not limited to, a height map, a three-dimensional model, carving a surface with a curve, or by mathematical (such as music related or geometrical) functions. On the surface that lies within a three-dimensional workspace, virtual instruments may be placed as specified in initialization file definitions.

In certain example embodiments, a virtual instrument contains a size and location within the surface, a priority to determine which instrument to use if more than one overlaps with another, a haptic feeling associated with this virtual instrument (e.g., friction), as well as the definitions for the MIDI instruments contained within each virtual instrument. Each virtual instrument may contain one or more MIDI instruments, which can use a particular MIDI instrument number, a MIDI channel to send the data, a scale to use for the notes to be played, an octave range, a chord definition including the mode used to create the chords, and a mapping definition that defines the haptic parameters used to produce the MIDI data that drive the sound output.

One example embodiment of the invention uses the MIDI instruments from the standard General MIDI (GM) set, of which there are 128 instruments to chose. The MIDI channel determines which of the available 16 MIDI channels to send the sound data, which is important especially if external MIDI devices were used. The scale is specified as a list of up to 12 notes from an octave that will be played from the haptic input values. If the list were to include the integer values 0 to 11, then the notes in an octave may be played, providing the ability to use notes available to the MIDI sound source. This list may, however, be much shorter, such as, for example, a few values that limit the notes used when sound is generated, providing the ability to limit the notes played to within a scale that may be determined by the user. These scales may allow random haptic input to produce good sounding musical results, if chosen properly.

In certain example embodiments, the chord definition specifies a list of integer values that would be used in conjunction with the base note as determined by the scale. This may be a list of up to 10 values for each row with up to a total of 12 rows. The 10 values may represent the chord to be played for the current note, the number 10 being chosen as it is the maximum allowed by the human hand, but may be any arbitrary number. Each of these 10 values may be specified uniquely for each note in an octave, providing the possibility of a different chord for each note in an octave if that is the desired outcome. The values in this chord list may include negative or positive values that are added to the base note and played back at the same time as the base note. This means that for a given base note, the values in the chord list may be added to this value, or effectively subtracted in the case of negative values, and send as MIDI note-on events at the same time that the base note is produced. The use of this chord definition may be specified by the chord mode, which can include the choice of: no chords, one chord for all notes, and chord per note. No chords mode plays the base note. One chord for all notes mode takes the same values as specified in the first row of chord values and adds those to each note in an octave when played. This mode may allow for very musical chords with relatively little effort as the chords played are always similar in sound regardless of the note. Since the standard 12-octave scale does not make for chords like this to be played easily on a standard instrument, this mode is convenient for musical creation without much musical knowledge. The chord per note mode may allow for more standard chords that musicians are more familiar with, such as minors and majors, which do not have consistent note spacing for each note in an octave.

In certain embodiments of the invention, a color on the surface of the virtual object is mapped to a pitch, and vice-versa. Using color to represent pitch has always been of interest to musicians, who often feel that colors are representative of tone, mood, and feeling. The disclosed technology may allow color scales to be generated representing a unique color for each note in an octave. These colors could range from a full rainbow effect, having the most variety between notes, to a more subtle gradient change between notes. These colors may be specified as one color for each of the 12 notes in an octave, as well as a color to represent pauses in songs that play no note at all. Colors may be specified in terms of HSL color scales of Hue, Saturation and Luminance, with the hue value specifying the current note, as it is the easiest method to create unique colors created by a single continuous haptic control, saturation used as a way to differentiate more between similar colors, and luminance used to determine the octave.

The current note to be placed on the surface, as described in the aforementioned note placement methods, may be used as an index into the color scale array by taking the note, which may range from 0 to 127, and doing a modulus with 12, producing a number from 1 to 12 for each note given. The hue value returned may then be used as the base color for the area on the surface, with the saturation value determining that note's saturation, and the octave of the current note, as determined by dividing the note by 12 and taking the integer of that, may be used to lighten or darken that color based upon a higher or lower pitched note, respectively. This means that every octave on a keyboard, for example, may have the same color mappings for each note, but with different lightness or darkness as determined by each octave. In an alternative embodiment, a different color may be chosen for each octave, with a different lightness or darkness for each note within that octave.

In certain example embodiments, in the same way that pitch may be used as a lookup for colors, color may be used to determine pitch using a reverse-lookup method. The color returned by an object at a certain point can be compared to the colors in the color scale array to determine which base note the hue represents and which octave the luminance represents. This may then be used to recreate a whole note within the MIDI note range. This allows for such actions as colorful surface exploration haptically and musically, as mentioned below.

In an example embodiment of the invention, text based data files are used in the initialization of parameters and in setup algorithms. The data required for setup of the Studio environment, Instrument Surface, Virtual Instruments and MIDI Instruments may be contained within text files filled with flags and data values corresponding to each of the editable parameters associated with these classes. Most, if not all, of the parameters worth changing without the need for recompilation of the disclosed technology may be included within these files, allowing settings to be changed while the disclosed technology is operating and reloaded into the studio by reopening the modal definition that this file corresponded to. These files allow the definition of different modes of operation of the invention, such as, but not limited to, song mode studios, instrument mode studios, and the tutorial mode studios used as an introduction to the software. The data parsed from the files may be used to specify the value of member variables within these classes, providing the information necessary to play a unique instrument surface. These files may include, but are not limited to, instrument surface initialization parameters, studio initialization parameters, and one or more virtual instrument definitions containing one or more MIDI instrument definitions. Each variable value can be contained next to a flag specifying the variable type, or with a list of values within the context of a flag. This method makes for both easy parsing, modification and creation of the files.

In another example embodiment of the invention, surface related algorithms are used in creating a song curve. In a java program, for example, a user may click different areas on a JPanel to specify control point locations. A second pass link can then control these points with a Bezier curve where every point gets assigned an identifier which determines its order of drawing. Any other Spline could also be used. The program could automatically link the starting and ending of the Bezier curve to the left and right edges of a drawing Panel. Substantially any curve starting and ending points can be defined. The resulting curve may be saved to a binary file that ends with a .cpt extension where the layout may include an 8 bytes header chunk where the first 4 bytes represent an integer specifying the width of the surface covered by the curve while the other 4 bytes represent another integer specifying the height of a chunk of size (Width*height*4 bytes), holding integers representing the identifiers of the curve points which are now ordered in a grid layout. A zero ID may mean that the current grid cell has no curve point in it and thus should be discarded.

In one example embodiment, to interpret curve points into a program, a program implementing the invention reads ID numbers into a temporary 2 dimensional array of integers or a structure (CurvePoint) that has 2 variables. An integer called pointlD, and a Tuple3f (Vector with x, y and z elements) called coordinates may be used to store the data. The class CurvePoint can implement the operators > or < returning either true or false based upon the comparison of pointIDs of two instances of the class CurvePoint. For example, if an instance of CurvePoint, >curvePoint1<, with member variable pointlD set to 1, is compared against another instance with the operator, >curvePoint2<, with an ID of magnitude 3, the return value will be false: (curvePoint1>curvePoint2)=false. The need for the greater or less operators in the class CurvePoint is to read in the curve points into a linked list, such as, but not limited to an std library vector <class T>, and to sort them incrementally for the drawing of the final curve to our OpenGL canvas. The program may then scan every single element of the array unsortedPoints by the mean of two for loops, with the second loop being nested within the first.

If at a grid point [h][w] the id is a positive non-zero value, the program may create a new instance of CurvePoint where the coordinates member variable is set to (w, MaxSurfaceHeight, h), and pointlD may be set to the value contained in point[h][w]. The program can push that instance into a linked list and move on to the other elements of unsortedPoints. Once scanning and analyzing the elements of the unsortedPoints array is completed, the program may sort the linked list now containing the valid non-sorted ids. The std::vector container can be used instead of a custom built linked-list structure along with the package <algorithm> which defines the function sort( ) that takes two iterators; one pointing to the start of the linked list and another pointing to the end.

After sorting of our points, the program may run between 2 to 5 smoothing passes on the vector containing the curve points to eliminate most of the jaggies that could result of two or more points being too close to each other. A smoothing pass may comprise taking the currently indexed element of the linked list as well as the previous one, averaging their locations projected on the x-z plane, and then storing it back into the current point. Upon creation of a smooth curve, where the points are at height MAX_SURFACE_HEIGHT, the program can go through the list of points and pass each elements of it to a function that carves a hole into the surface at a location currentCurvePoint.x and currentCurvePoint.z, and initially set it to MAX_SURFACE_HEIGHT. The program can then run between 4 and 6 smoothing passes on the entire surface where it averages the current surface point's height with the 8 neighboring vertices. A 3×3 smoothing filter, or other appropriate filter, may be used. The method of creating a song path by placing the notes on the three-dimensional surface is described above.

In another example embodiment, MIDI related algorithms are generated to be implemented by the invention. To setup and initialize the algorithms, the MIDI engine may be based upon directMIDI wrapper class for the directMusic MIDI environment of DirectX. Test programs may be used as a basis for setup and initialization of this MIDI environment. Standard port settings for internal General MIDI (GM) output may also be used, providing the full GM musical instrument set to the desired application.

To prepare MIDI file data, the appropriate MIDI calls that may be necessary for MIDI file writing may be determined and called throughout the program to ensure the MIDI file plays back properly. To ensure this, MIDI commands such as change of instrument, which involves downloading of an instrument to a port, may be accompanied by the appropriate patch change to allow the corresponding MIDI instruments to load in MIDI file playback. Although the directMIDI structure may allow twice the number of MIDI instruments, the MIDI instrument set in one embodiment may be limited to the 127 available to General MIDI and MIDI playback software, such as, but not limited to, Windows™ Media Player and QuickTime™. Each of the MIDI commands sent out to the internal MIDI synthesizer can be stored into a MIDI event array, as required by the MIDI file writing dll, while recording is enabled. This array may include the message to be sent out in the appropriate three byte structure of a one byte command type, and two bytes of data. Each of these command elements may also include an appropriate timestamp as determined by a MIDI clock within the application. The MIDI clock may be based upon a precise application-wide clock keeping track of elapsed time, and be incremented at each predetermined MIDI tick, which is determined by the tempo of the song and a number of parts per quarter note. A standard tempo of 60 beats per minute may be chosen for the MIDI file writing, and 96 parts per quarter note may represent the resolution within this tempo. Each musical bar may be divided into 4 quarter notes, each bar falling on a new beat. Since there are 60 beats per minute, the time calculations may be easy to handle, as this represents one beat a second. Within each second passing of the global application clock, four quarter notes passes, each quarter note having the resolution of 96 steps. This means that there are 4 times 96 steps, or 384 steps per second of resolution. The total number of MIDI ticks since the beginning of recording can be continually incremented every 384^{th} of a second, producing integer values that may be used as timestamps within the event array. This event array may require pre and post information related to the setup of the MIDI file, and may then be processed by the MIDI file write dll, producing a final MIDI file output.

The multitude of MIDI and haptic parameters available within the disclosed technology may enable complex and diverse mappings of haptic input to MIDI control output. A class structure may be designed to incorporate these mapping possibilities as generally as possible so that it may be easy to expand as time goes on. Using the multi-mapping features, one or more haptic input value may be used to modify one or mode MIDI output value. Each haptic device value, including the gimbal locations, pressure, and stylus button states, can return floating point values from 0 to 1, and can be translated into the standard 0 to 127 values that the MIDI control locations expect, through a series of filtering functions. These filters may include the initial haptic values translation, providing alterations to the 0 to 1 haptic values, including a min and max, sensitivity altering the growth rate of these values, and a center point determining where 0 falls through the haptic values. This allows inverse transitions of values such as, but not limited to, the haptic mixing algorithms, which determine how multiple haptic values get mixed with one another, including scaled 0 to 1 addition and multiplication and offset from a base using a secondary haptic value, as well as the min and max change to the MIDI value parameter within the MIDI range. The haptic sensitivity may be used for gimbal controls on a haptic interface device, where the amount of twisting required to reach a maximum is a desired variable, allowing more subtle twists to produce the same effect as twisting the entire range of the haptic control. The center point of a haptic interface device allows for either inverted ranges of the control, such as going from 1 to 0 rather than 0 to 1, or for the center of a gimbal, for example, to return 0 rather than 0.5, which is important for controls such as modulation versus pitchbend that both treat the value of 0.5 differently.

In certain embodiments of the invention, notes from songs or from scales are produced when the surface is explored. Notes may be played when the surface is touched, much in the way that most musical instruments must be touched to produce sound. This may be accomplished by determining the current virtual instrument, surface contact, note or notes to be played for each MIDI instrument contained in a virtual instrument, producing the notes, and producing the other MIDI controller value commands mapped to this MIDI instrument. The current virtual instrument may be determined by checking the current location on the surface relative to the size and locations of the virtual instruments, as specified in the initialization files.

In certain embodiments, once the index of this virtual instrument is determined and contact is registered as true as based upon collision with the surface, the MIDI instruments contained may be extracted and cycled through, based upon the current haptic values sampled at each iteration of the sound thread loop. For each iteration, the haptic values can be read in from the device, location on the surface, color, etc. can be read into a data structure, and the multi-mapping classes may be queried to determine the parameter values to send out for each MIDI instrument. If a haptic value or values are mapped to a particular MIDI parameter, the values may be returned within the MIDI range of 0 to 127, and used as the value sent out via a MIDI command call done through the directMIDI classes. If this value is less than 0, it may be considered an unmapped item, and no MIDI controller value need be sent out. This may help to reduce the number of MIDI commands sent to the system and recorded into the MIDI file, thus reducing processor effort and MIDI file size. On each iteration of the sound thread, a loop of each MIDI instrument contained in the current virtual instrument may be traversed, producing the MIDI commands related to the current virtual instrument. Controller values such as pitchbend and modulation may be sent out when they have been updated, regardless of contact, but note events may be sent when a new contact is made with the surface, or the haptic stylus is sliding to a new note contained on the surface. The previous contact may be stored to determine if a new note has been played, and new notes may be triggered if either a new contact has occurred, or contact is present and the haptic interface device has slid to a new unique note. The current note to be played may be calculated by checking either the scales or song notes specified for each MIDI instrument in the initialization files. In the case of scales, the input haptic values can be indexed into the size of the scale array, providing the MIDI notes contained within the desired scale, whereas the song notes may be determined by checking the values of a complex song mapping array providing the song notes present at each coordinate on the surface, as determined in surface creation. If chords are to be played, the current note may be determined by the contact coordinates or other mapped haptic input values, and the proceeding notes to be played in conjunction with this note to produce a chord may be generated by looking up the note offset values in the chord array and adding them to the current note. Although one MIDI command may occur at a time per channel, or effectively per MIDI instrument, events such as note-on can actually occur one after another, making chords a succession of notes. This may occur within a relatively small timeframe, such that the sound lag is often unnoticeable.

In certain embodiments of the invention, when producing the instrument surface colors, the note representing the area on the surface can be used to determine the color at that area on the surface. In a song playback mode, the curve representing the song notes may be colored with the song notes of any of the MIDI instruments. The colors on the remainder of the surface may be determined by producing a topographical mapping of the remainder of the surface based upon the heights around the curve, which falls in the bottom of a valley. An array of pitch values may be produced for each MIDI instrument as a lookup when note on events are to be produced, and may also be used to determine the color for the surface, which is representative of a specific set of song notes. This color may be produced by a function that takes the current note, and looks up in a table of 12 values to determine which color that note represents. Each note in an octave may have its own color, with, in one example embodiment, lightness and darkness of that base color representing higher or lower octaves, respectively. A modulus operation may be performed on the note (ranging from 0 to 127) with the value 12, producing the index into the array. The octave may be determined by taking the note, and taking the integer value of the note divided by 12. Since MIDI provides 11 octaves, the brightness of the color can be divided up into 11 parts, with the middle octaves representing middle brightness, or a sold shade of the base color. The color scale array may contain color values in an HSL (Hue, Saturation and Luminance) scale as this allows unique colors to be produced with a single hue value and lightness to be modified by another. Using a reverse lookup technique, notes may be extracted from colors by taking the current color of a surface to explore and determining which note it most closely represents. This may allow exploration of surfaces that can be loaded into the application and used as height and color maps. Other mappings are possible.

In another example embodiment of the invention, the disclosed technology provides tools to produce MIDI control and internal sound based upon three-dimensional surfaces. In one example embodiment, an Application Program Interface (API) is used to provide the capability of translating haptic parameters to sound parameters and actually playing and/or recording sounds. In this embodiment, general functions, taking easily understood arguments allowing the mapping, setup and playback of sound, could be used to produce a haptic MIDI toolkit. This may allow other haptic developers interested in sound, future haptic sound application makers and game developers to create and maintain volumetric surface driven sound data.

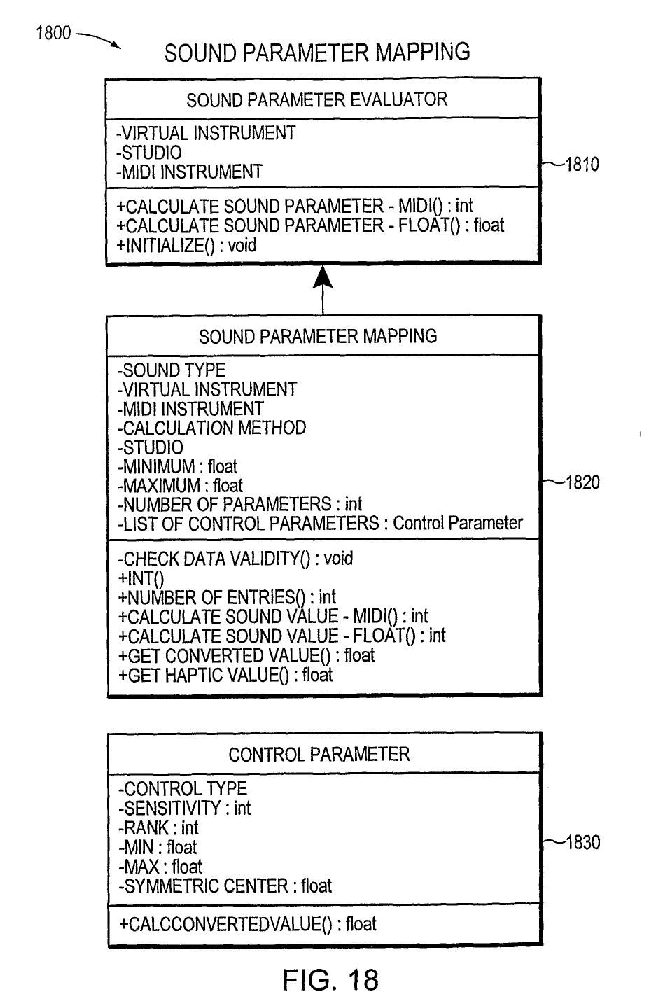

FIG. 18 shows example screen shots showing a set of option windows 1800 for sound parameter mapping. These option windows include a sound parameter evaluator window 1810, an option window for sound parameter mapping 1820, and an option window for setting a control parameter 1830.

In certain embodiments of the invention, the disclosed technology allows for the dynamic creation of a musically calculated song curve. The curve may be created by hand in a program created for a particular application, as described above. In other embodiments, however, a song curve is created using aspects of the song. In one embodiment, the song curve is linearly placed from left to right, following a sine curve shape, which does not utilize the three-dimensional space. The embodiment may involve the use of a sine curve of varying amplitude and constant frequency, based upon the timing within the song. The frequency may be determined by the number of unique notes, each note being placed on the upper or lower portion of a sine wave (i.e. the period can be based on half of the number of notes), and the amplitude of each half of the sine wave may be determined by the duration of the note, for example with longer notes having higher amplitude. This may allow the progression of the song to be both felt and seen, and can offer a way to help the user keep pace with the song, rather than by moving along a straight or curved line at a constant speed. This method is analogous to conducting the piece of music, in which each note of some part of the song is represented by an upward or downward movement of a haptic interface device, in the manner of an orchestra conductor.

In certain embodiments, software associated with the virtual musical interface may have the ability to specify which instrument's notes are to be used for coloring versus the generation of the curve, allowing the user to see the notes of one instrument, hear the notes, and focus on conducting the instrument based upon which part of the song they are interested in emphasizing. For example, if the notes of a rhythmic part of a song were used for the song, the other notes of the song would follow as the user conducted through these notes, emphasizing the rhythm of the song. Similarly, the melody could be used and other instruments could follow the progression of these notes as a leader. This method may be useful for learning rhythm, or how music works, and may be suited for musical education. This method may also be modified to work within a three-dimensional space by using the sine wave technique to determine the amplitude of the hills on which a winding curve could fall. The height of each hill could be the amplitude of the sine wave as calculated with the aforementioned method, making the height of the surface both a visual and haptic indication of the progression of the song.

In certain example embodiments, a user can both see and feel the length of notes, thereby enhancing the interactive experience. This means that long notes may fall on tall hills, producing the experience of holding the note for a long time, and short notes could produce small hills, producing also the feeling of short and fast notes that occur more quickly than the other notes. In this way users could feel staccato notes as well as see and hear them. In terms of the possibilities this offers, clearly musical education would benefit from the ability to hear, see and feel the ideas behind music theory that many new students may have trouble grasping.

In certain example embodiments of the invention, the disclosed technology has the ability to write out MIDI files. The song files played in song mode may be coded into the initialization files or may be read in directly from a MIDI file. In this way, each track, with its own unique note data may be translated into data to be played back on the surface. Since the MIDI files are written out using an array of MIDI event data, the functions that accomplish this could easily be translated into a playback engine for MIDI data from event arrays. The song mode may use the song notes coded by hand as array data that is translated into the notes present on the surface under the curve, or can use the track data from a MIDI file. One issue that this brings up however, is the fact that MIDI song files may be quite complex, as makers of these songs often put in hours of work to create a realistic sounding piece of music. The more data present, the more cluttered the surface could become with colors and note data, making the song more difficult to play. For this reason, in certain embodiments filters may be provided to pull out the necessary note and controller data that is required to play the desired portion of the song. These filters may include when to start in the song, when to end, what resolution of note data to include (i.e. quarter note, eighth note, sixteenth note resolution, etc.) and what tracks to incorporate.

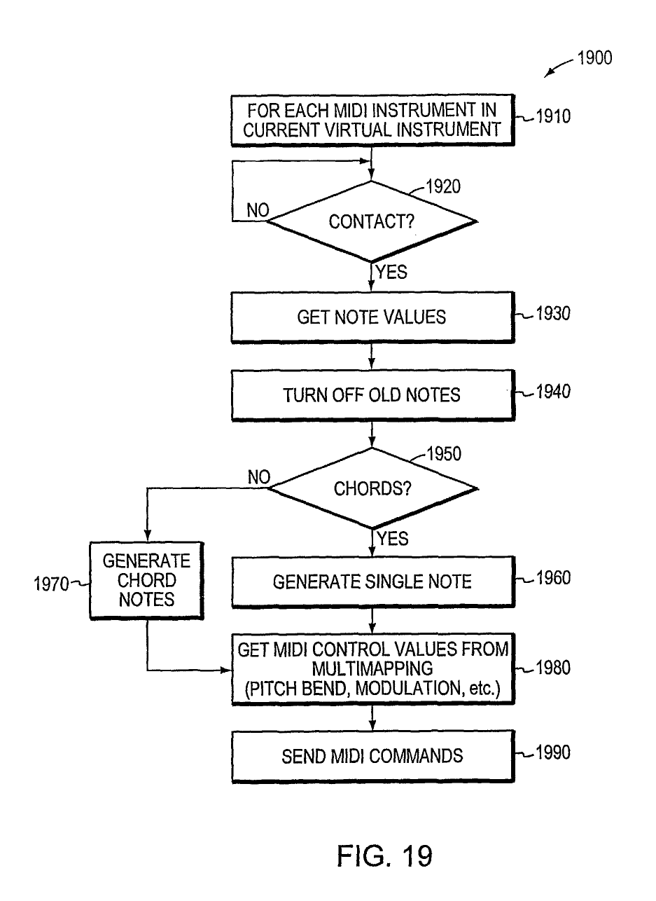

An example program methodology for generating MIDI events 1800 is shown in FIG. 19. The methodology may be carried out for each MIDI instrument in a current virtual instrument 1910. Contact 1920 is made with the virtual instrument, after which the program gets the required note values 1930, and turns off the old notes 1940. The program then establishes if the note values are chords 1950, after which it may generate either chord notes 1970, or single notes 1960. MIDI control values may then be obtained from multi-mapping 1980, after which the MIDI commands are ready to be sent out 1990.

In some example embodiments, a standard Mac, PC, or Linux window-based word area may be used with, for example, an OpenGL studio workspace, advanced editing, saving, and other features to provide additional functionality to more advanced users. For example, software may be designed with examples of the ability to load studio definitions that novice users can try and play with for recording, playback, and experimentation. More intermediate users could load individual virtual instrument definitions and place them within the instrument surface, edit the instrument surface, change colors from presets and experiment with more hands-on generation of the instrument settings. Advanced users could have access to the actual mappings associated with each individual MIDI instrument, as well as appearance and functional settings that are preprogrammed in the preset definitions. These users could have access to the colors that make up the color scales, the MIDI instruments used for each MIDI instrument, the advanced MIDI instrument mappings, chord definitions and scales, as well as the algorithm presets that make up the surface height maps used to generate the three-dimensional aspects of the instrument. Advanced mapping settings could also allow the user to setup definitions that work with MIDI sequencing software and synthesizers in order to control external sound sources and work with multitrack recordings.

In another example embodiment, three-dimensional surfaces of volumetric objects may be used to create the virtual musical interface. Spheres, cubes and other modeled volumes provide versatile surfaces to explore, hear and see. Song curves, instrument definitions, and other sound mappings may be placed on substantially any side of a volume, providing more flexibility than a planar surface of variable height. This may also allow the possibility of surfaces that can be molded and shaped like clay into a surface that is customized for the user's intentions. Similarly, game developers may be interested in the use of volumes that specify characters and objects on which sound could be mapped. This may also allow for abstract designs of multitrack song curves that span substantially all dimensions that, when created effectively, may be intuitive and useful for musical creation and modification.

In some embodiments of the invention, connection to external sound sources and MIDI recording programs can be useful to musicians familiar with these software packages. The disclosed technology may be used as a method of translating colorful three-dimensional volumes that may be felt and explored through a haptic interface device into control surfaces for synthesizers and effect units that produce studio-quality sound. This may increase the capabilities for real-time MIDI control. The disclosed technology may use internal General MIDI software synthesis to create sound, and/or the MIDI data being produced could be sent to external hardware or other software through MIDI ports or software MIDI connections and used to control any number of MIDI enabled software packages. Embodiments of the invention may also apply to any program with MIDI enabled, such as a video editing program or any form of software that exploits the versatility and simplicity of MIDI as a control source.

In certain example embodiments, a custom MIDI instrument is created. Internal General MIDI sound sets may be both limited control wise and lacking sound wise. Multimedia architecture, such as, but not limited to, directMidi for PC, or Apple QuickTime™ for PC or Mac, provide the ability to create custom MIDI instruments based upon samples as the playback audio source. These instruments may have any number of MIDI parameters mapped to affect the sound, rather than the limited set that General MIDI provides. These may be created, and their definitions could be added to the initialization files, allowing them to be part of the editable data to which an advanced user would have access. Samples may provide a simple way for a high quality sound to be chosen, either from a set provided with the application, or from new sounds as determined by the user, with little effort required to make the instruments or for the computer to play them back.

Certain musicians are familiar with standard musical MIDI input devices, such as MIDI keyboards or guitars. These devices may be incorporated as input devices to the application, providing a source for control along with the haptic input device. In one example embodiment, a bowed violin physical modeling instrument may be best played by holding notes on a keyboard or similar device with the left hand, and bowed with a haptic interface device representing a bowing handle, such that notes could be played by the user and accurate bowing could take place.

In certain embodiments of the invention, more than one virtual instrument is contained within the same area, with a priority value specifying which virtual instrument will be played when more than one overlap. This allows more complex virtual instrument surfaces to be created, with patches within larger virtual instruments specifying variation instruments similar to the larger virtual instrument, or entirely independent instruments. Layering supports blending between layers that are hidden using pressure, for example. When more pressure is applied, the lower priority instruments begin to fade in when they were silent before. This allows more the user to feel that they are burrowing into other instruments and to hear them come in as they apply more pressure. The mapping definitions of the disclosed technology may support crossfading and fading in of sounds that are hidden under a specific area.

In one example embodiment, the disclosed technology is used to explore sound generated in a three-dimensional modeled environment. Here, sounds produced by a specific environment may be examined using MIDI as the control parameter for external synthesis software, mixing software, internal MIDI controlled sample playback and alteration, and/or other sound producing or modifying applications. For example, a three-dimensional model of a room such as a tunnel or cathedral may be generated, where touching or editing of a specific area changes the reverberation characteristics of a sound played within this space. The device may be used to specify placement of a sound source within this environment, or to modify other environmental characteristics affecting the sound. Another example would be that of a movie theater or home theater system that incorporates the 5.1 or higher surround sound technology, as a tool for producing mixes for movies and other multimedia sources that incorporate the use of spatial positioning of sounds. The location of a particular sound may be touched on the three-dimensional environment representing the space, and heard through the sound system at that location within the environment. Since audio mix down and sequencing software may offer reverberation and other effect unit processing and 5.1 and above surround sound mixing capabilities, as well as MIDI capability, these applications may be implemented using external software and a three-dimensional model with the appropriate MIDI mappings for the associated parameters. Similarly, synthesis software may be used to receive MIDI data from a three-dimensional environment and create sounds either associated with the environment or simply modified by movements within an arbitrary environment, providing more expressiveness to musicians using software or hardware synthesis.

In another example embodiment, the invention is used for real-time haptic control of audio software parameters. Using a haptic device more akin to movements of the fingers and hands, haptic control of software synthesizers, audio sequencers, waveform editors, and other sound tools may be obtained. Using a haptic sound toolkit, manufacturers of these products allow haptic control of commands normally controlled by the mouse, providing a more realistic feeling to the user and hands-on control of the software environment. For example, software synthesizer and mixing programs may offer multitudes of knobs, switches and sliders that are controlled most commonly by the mouse or by an external MIDI device having real versions of these knobs, switches and sliders. It is possible to use embodiments described herein to realistically convey the touch-based aspects of these controllers, such as the size, shape, texture and/or tightness of movement of a knob or slider. A haptic hand controller, such as a glove, may be represented in a graphic display, for example, as a translucent hand representing the user that grabs the controls on the screen and provides haptic sensation to the user based on her interaction with these controllers. Since many musicians prefer a hands-on control of their music production, haptic sensing of virtual objects on the screen provides a realistic environment more closely related to that of a real studio. Similarly, other more abstract controls may be provided haptically, such as controlling the playback and location finding within a sequencer. Likewise, control of waveform editing or matrix note editing commonly found in the MIDI section of sequencers may be performed using haptic devices, providing the feeling of raising or lowering the amplitude of a waveform, editing out sections of the waveform, or moving or stretching a note within the MIDI matrix editing.

In another example embodiment, the invention is used to provide physical modeling of a real instrument. Using a three-dimensional model of an instrument such as drums or a stringed instrument, realistic control and feel of the instrument may be simulated. For example, the physics of an instrument may be programmed within the visual environment to provide the simulation of strings or drum heads oscillating, decaying, and moving in realistic manners. This physical data may be translated into control parameters for MIDI control of software synthesizers that have the ability to produce realistic simulations of these instruments. Rather than rely on trying to control a violin or drum with a keyboard, these instruments may be played on the screen and hit, bowed, and felt the way they are when actually used. This provides a way to use physical modeling to control both the graphical and auditory aspects of instruments as one. Similarly, a piano with realistic feeling may be provided within a virtual environment that may be played with haptic gloves. With this means of control and the others described above, the software music packages may be controlled with a keyboard/mouse combination (although this could be simulated haptically using the same principles for the music keyboard to create a virtual computer keyboard, and haptic glove movements may be used to create mouse movements). This means that musicians may have access to a virtual environment for playing and editing musical compositions as though they are present in a virtual studio.

In yet another example embodiment, a virtual DJ program is created with haptic feel and feedback. Virtual DJ programs may provide ease of musical retrieval and playback. However, they may not provide satisfactory user control via a keyboard/mouse setup. Certain professional software may provide MIDI control of settings, allowing knobs, sliders and buttons on an external MIDI control device to provide more hands-on control of the mixing. Using a haptic control device such as a set of gloves, knobs, sliders and/or switches that can be felt, as described above, provide a means of working with the software on the screen as though it is hardware. This also allows virtual turntables to be present, allowing the user to manipulate realistic feeling and behaving vinyl spinning on platters on the screen. Here, the spinning vinyl may be felt as it spins beneath the haptic fingers, and the movement of the surface may be felt when manipulating the turntables, such as through scratching.

The invention may provide, in another example embodiment, a tool to be used in teaching music to a child or adult. Since learning of a new musical instrument may be difficult, time consuming, and costly, virtual instruments may offer a solution to both families and schools looking to teach music to children. Rather than buying a single musical instrument that will both degrade over time and use, and that the child may lose interest in, a haptic device and simple song learning tools software may be purchased providing the child with the ability to learn music theory and composition without being limited to one musical instrument. Just as schools offer bands that the children may join, the haptic learning tools may provide band backup that the student follows and becomes a part of, as well as the ability to work in conjunction with other students through networking to provide a synchronized “band” of haptic music devices following a leader providing the conducting for the piece of music. Such an implementation may make use of multiple users connected via a network, for example, the internet.

In another example embodiment, the invention is used for music and sound production for gaming. Using a toolkit based upon the disclosed technology, game music and sound may be developed using simple calls that can produce complex sound. With the use of multimedia architecture, such as, but not limited to, directMidi for PC, Apple QuickTime™ for PC or Mac, or a proprietary synthesis method that uses MIDI, complex and easily assignable sound control may be readily available. Since synthesis may involve costly computations, writing code within a game to produce sound may not be the best approach when speed of the machine using the game is a concern. Synthesis may also be quite complex, especially for people who are not used to programming sound. The advantage of using the invention described above to develop for games would be the fact that samples of sounds could be used rather than synthesized. Samples may be purchased and downloaded for free through various means, as well as created from synthesis programs that are also readily available. Using these synthesis programs saves the game programmer from making a synthesis engine and may be much more versatile than one that a game programmer may make for the game itself. Even though the samples may be static in terms of the sound they can playback, complex fading between sounds, modifications of the sounds, and layering of multiple sounds may be accomplished using a haptically rendered virtual musical interface. This interface may also be a standard from which future games are developed, making the algorithms used to setup game sounds using the interface calls reusable by the game programmers. For game music and sounds, algorithms may be created for determining when sounds are triggered based upon actions or situations within the game, how they are modified, and when and how songs are played. Since the modifications to the sound within the disclosed technology may be performed using haptic and environmental variables such as surface coordinates, haptic bending and twisting, pressure, velocity, etc., which range from zero to one, substantially any kind of variable data ranging between zero and one could be used to modify the sound in some way as determined by how the programmer decides to map the data. Within a game involving three-dimensional objects and characters, coordinates on bodies may be used as variables to modify the sound of fighting between two characters. For example, a chest of a character could be treated as a three-dimensional surface shaped as a chest containing x, y and z locations for any point on the chest surface. When a different point is touched, such as when hitting or otherwise striking the character, the values for pressure applied to the surface at a certain coordinate may contribute to changing the sound in terms of how loud the character reacts (volume of the sound), how quickly they react (attack rate of the sound), and what kind of reaction they have (crossfading between multiple sounds). Since these values are translated into simple MIDI calls that are each very small and efficient, complex sound modification and generation can be achieved using very little sound programming. Music for games may also be modified in the same manner, using simple values for coordinates and other variable factors that can make the music change in speed, pitch, volume and other factors that modify the intensity and mood of the situation and be unique in each instance.

In yet another embodiment of the invention, graphical representations of data obtained through scientific experimentation or mathematical generation is produced and translated into a three dimensional surface that may be explored and heard. A user may thus see, feel and hear the data represented on the screen at any specific point or set of points using the haptic device to explore the surface. Just as data can be translated in different ways graphically, the data can be translated into different sounds or modifications to those sounds based upon user specification. An example of this may be a fractal music exploration program that either loads generated fractal images or produces them programmatically, generates a surface based upon their coloration and shading for surface color and height, and generates musical models based upon chosen presets or user settings. Musical software that translates fractal data into sound may use General MIDI as the sound generation method, which produces the sound data by a linear timeline based movement through the fractal data. Thus, the sound data is produced into a song that changes through time based upon the current fractal data, whereas a haptic fractal exploration program may be entirely controlled by the user where the point in the song is determined by the user. The user may specify the time in which she wants to play a given data point based upon when she decides to contact that point on the surface. In the same way, any kind of data may be translated into sound data using MIDI commands. Aspects in the data, or other sources of data from one larger set, may be used to determine aspects of the sound, such as pitch, volume, instrument, etc.

In another example embodiment, the invention is used as an expressive tool for autistic children or adults (or others who are cognitively challenged). One example of a program or hardware tool for use as a learning and expressive tool is a musical or sound device for autistic children. Since these children may not be capable of easily communicating without aids, devices that allow sound, voice or music to be manipulated are very important tools. Settings may be created in the disclosed technology to specifically target this area of learning and expression, providing common songs on colorful surfaces, new and unique songs on colored blocks, and different words, vocal sounds, or sentences on different colored areas on the surface. Since words, vocal sounds, and sentences may be sampled and modified in the same manner as a standard instrument, this type of application exploits a parameter mapping set within the disclosed technology.

In another example embodiment, the invention is used in realistic situation training programs. Both haptics and sound fit well into programs designed to simulate realistic situations faced by individuals for training purposes, such as instructional driving, military training and medical training. For each of these applications, sound may be critical to the realism of the experience. Rather than static sounds that do not have great flexibility, dynamic and environmentally affected sounds may be created using a toolkit based on the disclosed technology. As implemented with certain of the software applications described herein, environmental factors such as proximity to the first person view of the trainee, cause and effect parameters of the trainee's actions, and random factors associated with any real life situation may contribute to the variability of the sound.

In another example embodiment, the invention is used in the creation of movie soundtracks. In the creation of both the soundtrack and sound effect tracks for a movie, the disclosed technology may be mapped to provide an intuitive and flexible musical and sound creation tool based upon aspects of the movie. Since the surface may be colored in any manner, and since colors are often associated with moods, colors may be placed along the surface to represent different moods, feelings and situations within the movie. A conductor of the sound track may watch the movie and follow the feeling of the current time in the movie by moving around a surface representing the desired sounds. This could involve either newly created songs based upon haptic factors as in instrument mode, or the dynamic user-controlled playback of prerecorded songs as in song mode. Composers may be able to effectively express their ideas, emotions, and feelings about a scene by implementing mapping methods described herein to visually, haptically and audibly represent the scene. Similarly, sound effects may be mapped based upon colors and/or images that represent the desired sound additions or modifications in the movie.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

1. A method of haptically rendering a virtual musical interface, the method comprising the steps of:
(a) rendering a virtual object in a haptic virtual environment; and
(b) associating at least one parameter of the virtual object with an audio attribute to create a musical interface whereby a user is provided audio and haptic feedback in response to a user interaction.

2.-61. (canceled)

62. A method for producing audio output using haptically rendered virtual objects, the method comprising the steps of:
haptically rendering at least one virtual object in a haptic virtual environment, wherein each of the at least one virtual object is mapped to at least one audio parameter;
rendering a volume through which the at least one virtual object travels;
traversing the at least one virtual object; and
producing audio output corresponding to movement of the at least one virtual object through the volume.

63. The method of claim 62 wherein a virtual pointer denotes the virtual object being currently traversed.

64. The method of claim 62 wherein the audio output is modified by modifying the volume through which the at least one virtual object travels.

65. A method of modifying audio attributes of a musical composition, the method comprising:
accessing audio attributes associated with a musical composition;
associating at least one of the audio attributes with a graphical representation of the musical composition; and
modifying the associated audio attribute in response to an interaction directed at the graphical representation of the musical composition.

66. The method of claim 65, wherein the audio attributes include at least one of a tone, volume, pitch, attack rate, decay rate, sustain rate, vibrato, and sostenuto.

67. The method of claim 65, wherein the audio attributes are accessed from a MIDI file.

68. (canceled)

69. The method of claim 65, wherein the musical composition includes at least one of a voice, a monody, and a polyphony.

70. The method of claim 65, wherein the graphical representation of the musical composition includes at least one of a three-dimensional graphical surface and a three-dimensional volume.

71. The method of claim 70, wherein the graphical representation represents a range of modification of the at least one audio attribute.

72. The method of claim 70, wherein the at least one audio attribute is further associated with at least one of a texture, a coordinate location, a color, a depth, and a height of the graphical representation.

73. The method of claim 65, wherein the interaction directed at the graphical representation of the musical composition is received via an input device communicatively coupled to a digital data processing device.

74. The method of claim 73, wherein the input device is at least one of a mouse, a spaceball, a trackball, a stylus, a sensory glove, a voice-responsive device, a haptic interface device, a game controller, a remote control, and a transceiver.

75. The method of claim 65, wherein the interaction directed at the graphical representation of the musical composition corresponds to a haptic interaction associated with at least one of a force, a direction, a velocity, a position, an acceleration, and a moment.

76. The method of claim 65, wherein the interaction directed at the graphical representation of the musical composition corresponds to a tactile interaction associated with a texture.

77. The method of claim 65, wherein the modified audio attribute reverts to an unmodified state after a predetermined period of time.

78. The method of claim 65, wherein the modified audio attribute reverts to an unmodified state upon occurrence of an event.

79. The method of claim 78, wherein the event corresponds to at least one of a cessation of a haptic interaction, a cessation of a tactile interaction, a recordation of the modified audio attribute, a recordation of the musical composition, and a performance of the musical composition.

80. The method of claim 65, further comprising:
associating the at least one audio attribute with a haptic parameter, a value of the haptic parameter being manipulated in response to the interaction directed at the graphical representation of the musical composition, wherein the modified audio attribute is based at least partly on the value of the haptic parameter.

81. The method of claim 80, further comprising:
calculating the modified audio attribute based on a mathematical relationship with the haptic parameter.

82. The method of claim 65, further comprising:
performing the musical composition incorporating the modified audio attribute.

83. The method of claim 82, further comprising:
storing the musical composition with the modified audio attribute in a memory communicatively coupled to a digital data processing device.

84. The method of claim 83, wherein the stored musical composition is stored in a MIDI file format.

85. The method of claim 83, further comprising:
transmitting the stored musical composition to another digital data processing device via a network.

86. The method of claim 65, further comprising:
associating the graphical representation of the musical composition with a different musical composition; and
performing the different musical composition in response to another interaction directed at the graphical representation.

87. The method of claim 65, further comprising:
associating the graphical representation of the musical composition with at least one other musical composition; and
concurrently performing the musical composition and the at least one other musical composition in response to another interaction directed at the graphical representation.

88. The method of claim 65, further comprising:
displaying the graphical representation of the musical composition;
displaying another graphical representation of a different musical composition; and
performing the musical compositions based at least partly on another interaction directed at a space between the graphical representations.

89. The method of claim 65, further comprising:
performing the musical composition with the modified audio attribute, wherein the musical composition corresponds to an object within at least one of a game, a learning exercise, a simulation, a music production, and a multimedia production.

90.-102. (canceled)

103. A system for modifying audio attributes of a musical composition, the system comprising:
a plurality of audio attributes associated with a musical composition;
a plurality of graphical parameters associated with a graphical surface;
a mapping data structure associating at least some of the audio attributes with at least some of the graphical parameters; and
a calculation software process calculating modified values of the associated audio attributes in response to interactions directed at the graphical surface.

104. The system of claim 103, wherein the audio attributes include at least one of a tone, volume, pitch, attack rate, decay rate, sustain rate, vibrato, sostenuto, and base.

105. The system of claim 103, wherein the audio attributes are accessed from a MIDI file.

106. The system of claim 103, wherein the audio attributes are accessed from a non-MIDI file.

107. The system of claim 103, wherein the musical composition includes at least one of a voice, a monody, and a polyphony.

108. The system of claim 103, wherein the graphical surface represents a range of modification of the associated audio attributes.

109. The system of claim 103, wherein the graphical parameters correspond to at least one of a texture, a coordinate location, a color, a depth, and a height.

110. The system of claim 103, further comprising:
an input device directing the interactions at the graphical surface, wherein the input device is at least one of a mouse, a spaceball, a trackball, a stylus, a sensory glove, a voice-responsive device, a haptic interface device, a game controller, a remote control, and a transceiver.

111. The system of claim 103, wherein the interaction directed at the graphical surface corresponds to a haptic interaction associated with at least one of a force, a direction, a velocity, a position, an acceleration, and a moment.

112. The system of claim 103, wherein the interaction directed at the graphical surface corresponds to a tactile interaction associated with a texture.

113. The system of claim 103, wherein the mapping data structure relates haptic parameters with the associated audio attributes and graphical parameters, and wherein the calculation software process calculates the modified values of the associated audio attributes based at least partly on values of the haptic parameters.

114. The system of claim 103, further comprising:
an audio element forming an audible rendition of the musical composition, the musical composition incorporating the modified values of the associated audio attributes.

115. The system of claim 103, further comprising:
a rendering software process rendering the graphical surface on a display of a digital data processing device.

116. The system of claim 103, further comprising:
a MIDI file storing the modified values of the associated audio attributes.

117. The system of claim 103, wherein the modified values of the associated audio attributes are performed in at least one of a game, a learning exercise, a simulation, a music production, and a multimedia production.
